(19) United States
(12) Patent Application Publication
(10) Pub. No.: US 2009/0237777 A1
(43) Pub. Date: Sep. 24, 2009

(54) ENGINEERED NONLINEAR OPTICAL CRYSTAL COMPOSITES FOR FREQUENCY CONVERSION

(75) Inventors: Helmuth Meissner, Pleasanton, CA (US); Huai-Chuan Lee, Albany, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ONYX Optics, Dublin, CA (US)

(21) Appl. No.: 12/359,145

(22) Filed: Jan. 23, 2009

Related U.S. Application Data
(62) Division of application No. 11/891,016, filed on Aug. 7, 2007, now abandoned.

(51) Int. Cl. G02F 1/35

(52) U.S. Cl. 359/326

(57) ABSTRACT

Walk-off corrected (WOC) non-linear optical (NLO) components, devices and systems including one or more engineered WOC NLO crystal doublets. Such systems and devices advantageously increase the efficiency of an OPO operation. Devices are applicable to any uniaxial and biaxial NLO crystals in a wide range of wavelengths, e.g., from far ultraviolet to visible to far infrared. Devices employing engineered WOC NLO components according to embodiments of the present invention include any conventional frequency converting architectures. Systems and methods are also provided to unambiguously determine and correct walk-off for any arbitrary uniaxial and biaxial crystal orientation. The correct crystal orientation is also experimentally confirmed. This allows the use of WOC crystal doublet assemblies for a wide range of wavelengths and NLO crystals that until now have not been used because of low efficiency due to walk-off and inability of readily correcting walk-off.

### STATEMENT AS TO RIGHTS TO INVENTIONS MADE UNDER FEDERALLY SPONSORED RESEARCH AND DEVELOPMENT

NOT APPLICABLE

### BACKGROUND OF THE INVENTION

The present invention relates in general to nonlinear optical components and devices, and to lasers and more particularly to laser equipment in which the fundamental wavelength of an input laser energy of a solid state or gas or vapor laser is converted to different output harmonic wavelengths using nonlinear optical crystal components.

Laser systems are widely used in applications that include materials processing, tissue treatment and surgery, spectroscopy and defense applications. Laser systems operating at various fundamental wavelengths are advantageous for different types of operations in the following fields of use and others: materials processing, medical treatment and surgery, spectroscopy, defense, and scientific applications.

Different radiation wavelengths are desired for different applications. The radiation spectrum of most solid state lasers is relatively narrow with radiation output peaks occurring at fairly defined wavelengths. Output at the fundamental wavelength of a solid state laser oscillator is restricted by the availability of crystal and glass lasing media that are doped with available dopant ions.

Methods currently exist for generating additional wavelengths by converting the wavelength of a fundamental laser output to different wavelengths.

One technique for generating an output radiation beam having a different wavelength than that generated by the lasing medium is by the use of nonlinear frequency conversion crystals. Specialized nonlinear optical (NLO) crystals have been developed for use with currently available lasing media to provide an output wavelength different from the characteristic wavelength generated by the lasing medium itself. For example, U.S. Pat. Nos. 3,949,323 and 4,826,283, which are hereby incorporated by reference, disclose techniques for fabricating a harmonic crystal for use with lasing media where the crystal is responsive to an input fundamental wavelength to produce an output harmonic wavelength. Crystals useful for generating harmonic wavelengths include the following types: Potassium titanyl phosphate (KTP or KTiOPO₄), Lithium triborate (LBO or LiB₃O₅), Beta-barium borate (BBO), Potassium titanyl arsenate (KTA) and similar derivatives of KTP, lithium niobate (LiNbO₃) and magnesium-doped LiNbO₃ (MgO:LiNbO₃), Lithium iodate (LiIO₃), KNbO₃, Zinc germanium phosphide (ZGP, ZnGeP₂), silver gallium selenide (AgGaSe₂, AGSe) and others. A more complete discussion of nonlinear devices and crystals used in such devices can be found in W. Koechner, Solid-State Laser Engineering (2d ed. 1988) and R. L. Sutherland, Handbook of Nonlinear Optics) 1996.

In anisotropic media, the direction of wave propagation for an extra-ordinary wave is not generally the same as the direction of the beam propagation. Therefore, the ordinary and extraordinary beams of finite size will not completely overlap over the full length of a non-linear optical (NLO) crystal. The extraordinary beam is said to walk-off the axis of the ordinary beam. The angle ρ is called the walk-off angle and can be of the order of a few degrees. Frequency conversion efficiency with critically phase-matched crystal orientations in real optical birefringent media with real optical beams is strongly dependent on walk-off because beams that do not physically overlap cannot interact. Only for non-critically phase matched nonlinear optical crystal orientation for frequency conversion does walk-off not become an overriding factor.

While walk-off corrected (WOC) NLO crystals for frequency conversion in laser systems have been reported in the literature [see, e.g., references 1, 2, 3, 4, 5, 6, 7 included in Appendix A, each of which is hereby incorporated by reference], their use has not been widespread and they are not yet commercially available despite the benefits that they offer. Among the factors that may be responsible for this situation are the following:

(i) Some inconsistencies appear to exist in the literature with respect to how to rotate the second of a pair of crystals to obtain a WOC doublet.

(ii) The length of each crystal in the doublet does not appear to be considered an important variable in attaining WOC assemblies for high average power, energy per pulse, and wall-plug efficiency operation.

(iii) The phase matching angle of a given uniaxial or biaxial nonlinear optical crystal can only be oriented by X-ray diffraction with an accuracy of ±0.2°. When the difficulty of obtaining the optimal X-ray alignment accuracy is considered along with fabrication errors of the crystal assembly, the cut crystal angles may be off by more than ±0.20, thereby affecting critically phase matched NLO crystals.

(iv) Using a number of WOC doublets in series poses the problem of either requiring that anti-reflective coatings be deposited on each component, which limits the number of doublets that can be employed for an assembly, or optically contacting all components in a manner that does not necessarily lead to loss-free laser beam propagation through component interfaces.

(v) High power operation often is limited by laser damage on the surface and in the bulk of the NLO crystal, presumably due to an inefficient operation without WOC. The inefficient operation also has adverse thermal effects because it requires the use of high pump power to obtain the required output power. The higher pump power also increases the laser damage to the crystals.

Walk-off has been recognized as a limiting factor for the use of critically phase matched NLO crystals. There have been various attempts made to overcome this deficiency.

U.S. Pat. No. 6,544,330 uses diffusion bonded structures according to U.S. Pat. Nos. 5,846,638; 5,852,622; and 6,025,060 (all of which are hereby incorporated by reference) issued to one of the present inventors and appears to be an extension of AR coated individual elements. One important aspect of walk-off correction is to position the second component of a pair correctly with respect to the first component. Correction of walk-off in crystal pairs based on theoretical and experimental considerations is non-trivial and is arguably confusing when examining the prior art. For example, the statement in the '330 patent: “This “walk-off angle” is easily determined by one of ordinary skill in the art,” does not appear to correspond to the content of publications before and after its issuance. The publication that is cited as reference in the '330 patent for calculating walk-off angles ( Ref. 1: F Brehat and B. Wyncke “Calculation of Double-Refraction Walk-off Angle along the Phase-matching Directions in Non-linear Biaxial Crystals” J. Phys B At. Mol. Opt. Phys. 22 pp. 1891-1898 (1989)) does not include instructions of how to correct walk-off. The lack of recognizing the importance of variables that actually will result in improved conversion efficiency of frequency converting devices is one reason that WOC optical parametric oscillators (OPOs) are not commercially in use and why the '330 patent has not found use in the electro-optics industry. Examples of the difficulty and confusion of determining the orientation of WOC pairs are contained in the following publications, both prior art and after issuance of the '330 patent:

(i) Ref. 2: D. J. Armstrong, W. J. Alford, T. D. Raymond, and A. V. Smith, “Parametric Amplification and Oscillation with Walkoff-Compensating Crystals,” Optical Society of America Journal B, Volume 14, No. 2, pp. 460-474 (February 1997): FIG. 3 of this reference presents three different 180° rotations about three orthogonal axes of a crystal and concludes on page 464: “From this discussion it is clear that the crystallographic cut is not important for mixing with an odd number of e-waves because any combination of walk-off direction and sign of d_{eff} can be achieved by applying laboratory rotations of the crystal.” It is, however, not evident which crystal rotation to use for the second crystal in a walk-off corrected pair.

( ii ) Ref. 3: J.-J. Zondy, D. Kolker, C. Bonnin, and D. Lupinski, “Second-Harmonic Generation with Monolithic Walk-Off Compensating Periodic Structures. II. Experiments, Optical Society of America Journal B, Volume 20, Issue 8, pp. 1695-1707 (2003). FIG. 3a of this publication presents rotation of a KTP crystal along the input pump beam eω axis by 180° perpendicular to the propagation direction as instruction for walk-off correction while Ref. 2 instructs that only a different crystal cut may be used to produce a WOC crystal pair.

(iii ) Ref. 4: S. Carrasco, D. V. Petrov, J. P. Torres, L. Turner, H. Kim, G. Stegeman, J. Zondy, “Observation of self-trapping of light in walk-off compensating tandems”, Optics Letters 29(4), 382 (2004). FIG. 1 of this publication instructs to rotate each individual crystal by 180° around an axis parallel to the propagation direction to correct walk-off, in contradiction to Ref. 3.

(iv) Ref. 5: Serkland, D. K., Eckardt, R. C., and Byer, R. L., “Continuous-wave total-internal reflection optical parametric oscillator pumped at 1064 nm”, Optics Lett., v.19, no. 14, Jul. 15, 1994, p.1046-1048. A further demonstration that crystal orientation and walk-off angle are non-obvious and confusing variables in the prior art, the configuration of a cw TIR OPO using a critical angle phase matched lithium niobate nonlinear single crystal is shown schematically in FIG. 1. The 1064 nm pump does not form a closed loop and will exit after two loops. The generated 2128 nm beam forms a closed loop by TIR at three surfaces. The output is coupled out by a prism that lets out a 2128 nm beam by adjusting the gap distance between a prism surface and one of the TIR surfaces.

As shown in FIG. 2, a detailed look at the phase matched leg of the ring cavity reveals that the wave normal of the e-ray pump is at an angle p with respect to the generated o-ray wave normal, where p is the birefringence walk-off angle of the electromagnetic wave propagating along a 45.5 degree angle direction with respect to the optical axis.

FIG. 3 shows that the range of the phase matching angles correlates to the range of signal wavelength where the function Dk has roots.

$$Dk ( γ , λ s ) := ( - \frac{nox ( λ i ( λ s ) , γ )}{λi ( λ s )} + \frac{nex ( 1.064 , γ )}{1.064} ) - \frac{nox ( λ s , γ )}{λ s}$$

$$root ( Dk ( γ , 2.218 ) , γ ) \cdot \frac{180}{π} = 45.327$$

The phase match is achieved by mixing the 1064 nm e-ray pump with its frequency halved idler/signal parametric waves. The phase match angle is 45.33 degrees as shown in the plot in FIG. 4.

The calculated walk-off angle at the phase match angle of 45.33 degrees is 0.94 degrees using the following equation.

$$φ v ( γ , λ ) := [ [ a tan [ \frac{{nex ( λ , γ )}^{2}}{2} \cdot [ \begin{matrix}- \frac{1}{{( nex ( λ , γ ) )}^{2}} + \\ \frac{1}{{( nox ( λ , γ ) )}^{2}}\end{matrix} ] ] ] \cdot \frac{180}{π} ] \cdot sin ( 2 \cdot γ )$$

$$φ v ( \frac{45.33}{180} \cdot π , 2.128 ) = - 0.943$$

One notices that the value of the walk-off angle of 0.943° is different from the value of 2° reported in the paper.

This brief review serves as an illustration that the prior and more recent art to the '303 patent suggests crystal orientations that are ambiguous, not generally applicable and, at least to some extent, contradicted by subsequent publications.

The absence of information in the '303 patent on walk-off direction and compensation is not improved by choosing lengths of the NLO crystals such as 5 mm, 10 mm or 15 mm. There is only a cursory explanation of the dependence of length on interaction length and beam diameter. Data on input power and conversion efficiency appear to be lacking in Example (i) when using different NLO crystal pairs with individual lengths between 5-10 mm length. Conversion efficiency is dependent on the overall number of crystal pairs when converting input beams of different input power.

Accordingly, it is desirable to provide optical components and devices that overcome the above and other problems.

### BRIEF SUMMARY OF THE INVENTION

Embodiments of the present invention enable the engineered design of WOC NLO crystal components with an increase in average power of frequency converting NLO crystal devices that are pumped with a coherent radiation source, e.g., a solid state laser or a gas or vapor laser or other laser source. Scientific background information, experimental verification capabilities and fabrication techniques are provided herein. An assembly of engineered WOC NLO crystal doublets advantageously increase the efficiency of an OPO operation. Embodiments of the present invention are applicable to any uniaxial and biaxial NLO crystals in a wide range of wavelengths, e.g., from far ultraviolet to visible to far infrared. Devices employing engineered WOC NLO components according to embodiments of the present invention include any conventional frequency converting architectures.

Systems and methods are provided to unambiguously determine and correct walk-off for any arbitrary uniaxial and biaxial crystal orientation. The correct crystal orientation is also experimentally confirmed. This allows the use of WOC crystal doublet assemblies for a wide range of wavelengths and NLO crystals that until now have not been used because of low efficiency due to walk-off and inability of readily correcting walk-off.

The present invention eliminates the requirement of different crystal cuts and rotations of the second component in WOC pairs. This is especially useful from the practical viewpoint of fabricating components. It would be difficult to realize the advantages of walk-off correction when the two components of a crystal pair have to be oriented at different crystal cuts because of the inherently lower yield of crystal material during fabrication, inaccuracies of x-ray orientation and difficulties of adequately correcting walk-off.

The present invention allows for the optimization of the length of each crystal pair for a given beam diameter and walk-off angle. The lengths will rarely consist of even numbers such as 5, 10 or 15 mm lengths but will be engineered for high conversion efficiency and compact size.

The present invention also allows for the determination of the total number of crystal pairs as function of pump power.

The present invention also provides a technique of determining the critical phase matching angle when the refractive index is given by the Sellmeir coefficients for uniaxial and biaxial crystals. The walk-off angle corresponding to the phase matching angle for any uniaxial or biaxial crystals is then calculated. Since both x-ray orientation and fabrication of crystals of a particular desired cut for frequency conversion or other purposes have inherent alignment errors, aspects of the present invention provide techniques to measure the walk-off angle of a single crystal with great accuracy.

Engineered composites of the present invention result in a predictable high conversion efficiency that is dependent on parameters that include beam diameter, crystal orientation, walk-off angle, length of individual crystals, number of crystal pairs, pump beam wavelength and desired output wavelength. High power operation is facilitated by the high conversion efficiency. A decrease in laser damage is another result of the present invention because only a lower input power is required to reach a desired output power at a frequency-converted wavelength. Another benefit of the high conversion efficiency is the high beam quality of the output beam.

Wavelengths that have not been accessible with the prior art of frequency conversion are facilitated with the present invention. By way of example, yellow and orange laser output with high conversion efficiency becomes possible. These wavelengths have been elusive with frequency conversion of solid state lasers when using the prior art.

The engineered structures of the present invention may include WOC NLO planar waveguide architectures that are sandwiched between chemically vapor deposited polycrystalline diamond plates that are adhesive-free bonded to the waveguide core. These engineered components serve simultaneously the purpose of efficiently removing any excess heat that is being generated during laser pumping and frequency conversion, and also help compress the pump beam. The confinement is necessary for increasing the intensity of e.g. laser diodes or diode bars that may be used directly as pump beam. Alternatively, waveguiding is achieved by depositing an optical coating onto the total internal reflection surfaces and then bonding CVD diamond plates to it. This structure reduces scattering of the laser light on CVD diamond surfaces.

Another very attractive benefit of the present invention is the broadband output of an engineered WOC NLO composite that includes differently cut and oriented crystals corresponding to a range of output wavelengths without any tuning requirements. This device can act as spectrometer that can measure absorption of organic or inorganic species in fluids or gases.

The present invention enables the output of different distinctive wavelengths by combining WOC NLO crystals of different cuts corresponding to different phase matching angles into one or a number of components through which the pump beam and the converted beam propagate.

To mitigate laser damage at the input and output faces of the component, frequency conversion-inactive ends can be affixed to them. It is desirable but not required to have a matching refractive index between the inactive end sections and the active component. The interface between the ends and the active component may be coated with an antireflective coating to alleviate any differences in refractive index.

The present invention also includes devices that are based on the novel WOC NLO crystal assemblies of the present invention as add-ons to existing gas, vapor or solid state lasers or as new laser devices that efficiently convert an input wavelength into one or more output laser wavelengths. While any conventional laser pump sources may be used, it is possible to restrict the actual number of pump wavelengths to just a few of the most readily available ones at high power and beam quality because critically phase matched WOC NLO crystal pair assemblies provide access to different wavelengths at an engineered conversion efficiency. This is a distinct advantage over the prior art, which requires the use of more pump lasers at different wavelengths due to the use of noncritical phase matching.

The present invention also is applicable to walk-off correction of uniaxial and biaxial frequency-conversion-inactive crystals that are cut at arbitrary crystal angles. This may be useful for special crystal optics that are cut at arbitrary crystallographic orientations and laser components.

According to one aspect, an optical device for frequency conversion of an input radiation beam is provided that typically includes at least one walk-off corrected pair of critically phase matched nonlinear optical crystals, wherein the crystals are cut or otherwise formed such that i) each optical crystal has a pair of parallel opposing end faces, ii) the crystals each have the same length between end faces, and iii) an orientation of the optical axis relative to an end face of each crystal is the same for all crystals. In certain aspects, the at least one pair is arranged with a distal end face of a first optical crystal optically coupled to a proximal end face of a second optical crystal and such that walk-off of an input coherent radiation beam impinging substantially normal to a proximal end face of the first optical crystal is corrected upon exiting at the distal end face of the second optical crystal. In certain aspects, each optical crystal is a frequency-converting uniaxial crystal. In certain aspects the uniaxial crystal is selected from the group consisting of ZGP (ZnGeP2), YVO₄, β-BaB₂O₄, CsLiB₆O₁₀, LiNbO₃, MgO:LiNbO₃, AgGaS₂, and AgGaSe₂. In certain aspects, each optical crystal is a frequency-converting biaxial crystal. In certain aspects the biaxial crystal is selected from the group consisting of KTP, (KTiPO₄), LiB₃O₅, KNbO₃, CsB₃O₅, BiB₃O₆, CsTiOAsO₄, and RbTiOAsO₄.

According to another aspect, an optical assembly capable of correcting walk-off of an impinging radiation beam is provided that typically includes a pair of identical critically phase matched nonlinear optical crystals, each crystal having a pair of opposing end faces, wherein the pair of crystals have the same length between end faces and the crystals each have an identical cut of an end face relative to an optical axis of the crystal. In certain aspects, the pair of crystals are arranged with an end face of one positioned proximal to an end face of the other and with a 180 degree rotation of one crystal relative to the other along a direction of propagation of an impinging coherent radiation beam.

According to yet another aspect, a method is provided for accurately measuring the walk-off angle of an optical crystal using a measuring microscope. The method typically includes positioning an optical crystal between an object and an objective lens of a microscope, the crystal having a known length and an optical axis and parallel end faces, and determining a displacement distance between the two images of the object formed at a first end face proximal the objective lens, the two images being formed by an e-ray and an o-ray transmitting through the optical crystal. The method also typically includes determining a walk-off angle for the crystal based on the length and the displacement distance.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 is a schematic drawing of a solid-state ring cavity design of an OPO laser.

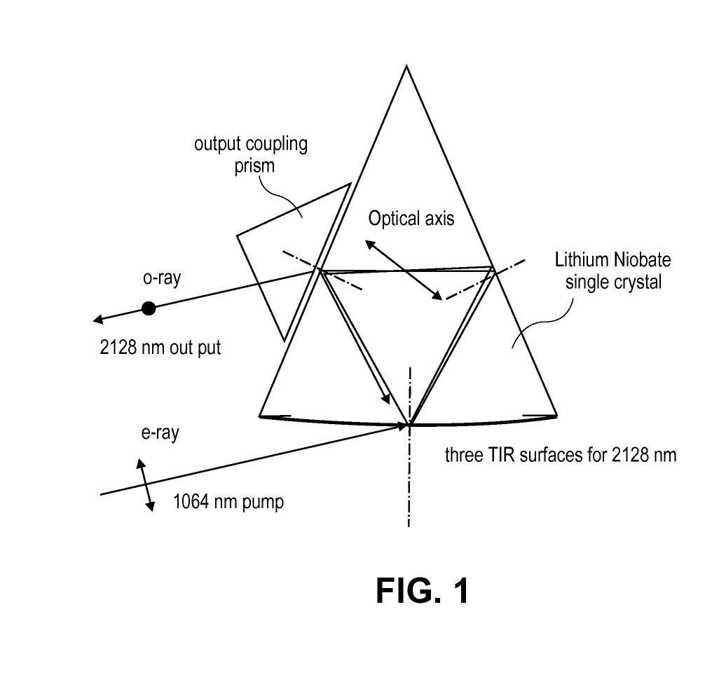

FIG. 2 illustrates a detailed look at the phase matched leg of the ring cavity of FIG. 1.

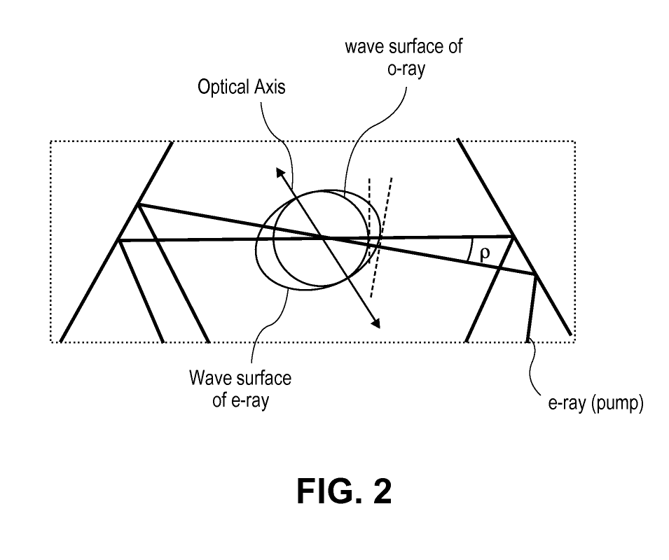

FIG. 3 shows that the range of the phase matching angles correlates to the range of signal wavelength where the function Dk has roots.

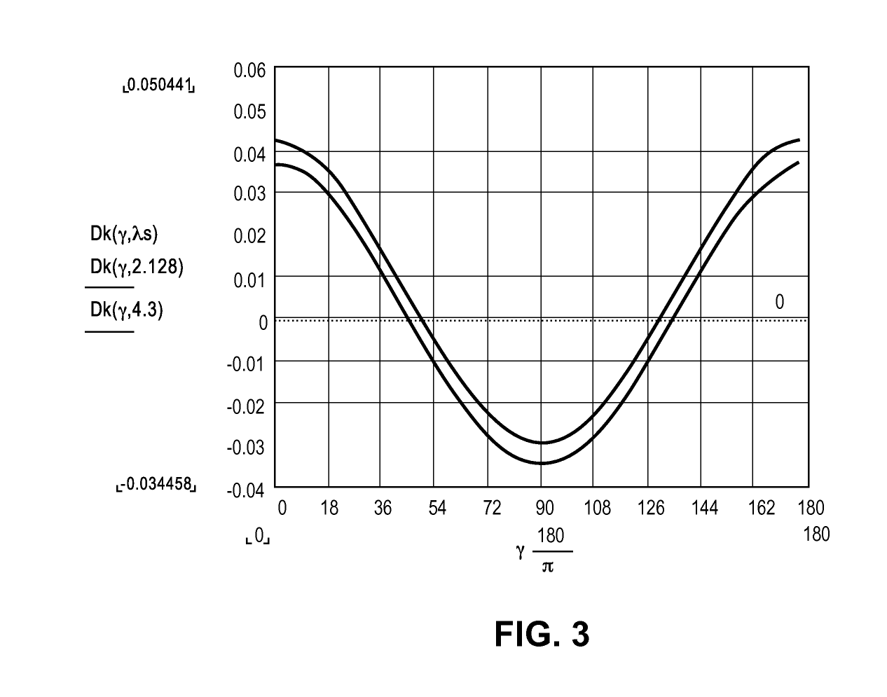

FIG. 4 shows that the generated signal wavelength correlates to the phase matching angle.

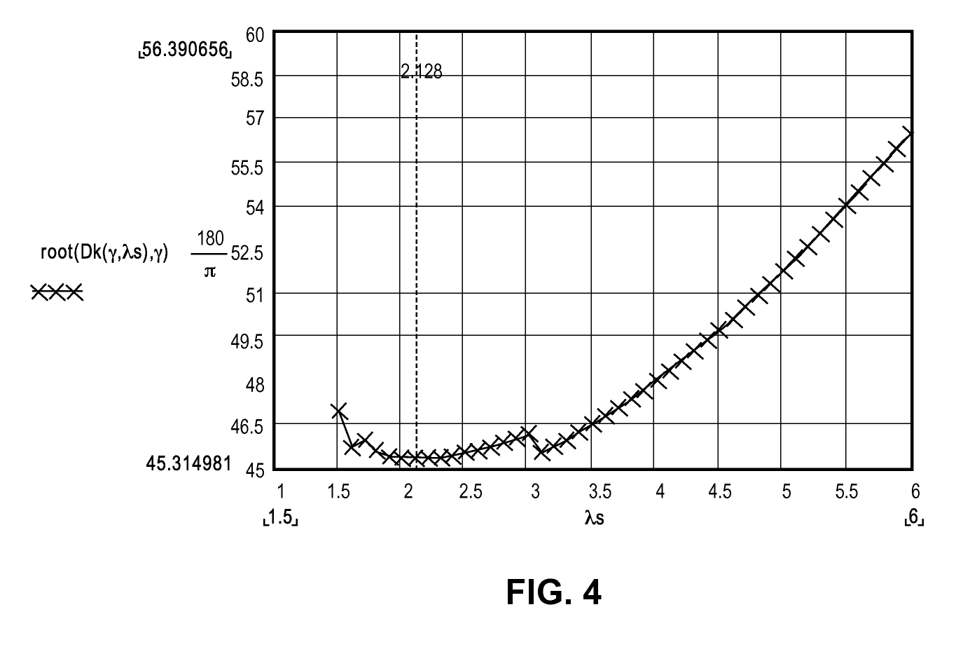

FIG. 5 illustrates that the convention of the angles, namely θ and φ, respectively, refer to polar coordinates, (θ, φ, r), that uses lattice base a as the axis <0,0,r>, and the lattice base c as the axis <0, φ, r>. Since optical properties of uniaxial crystals are axially symmetric about the c-axis, one can degenerate the 3-D problem to a 2-D one by using this convention.

FIG. 6 shows that the optical indicatrix of a positive uniaxial single crystal includes a spherical surface containing points r=n₀ of all θ and φ and an ellipsoidal surface that contains a line r=n(θ) and its traces by rotating 2π about the optical axis.

FIG. 7 shows the unit wave normal surfaces of a positive uniaxial single crystal.

FIG. 8 shows how to find the walk-off angle, α, graphically for a given ray direction θ, by: (1) Find the tangent line to the ellipse at the intersection of the line t, (2) Draw a normal line, s, to the tangent line from the origin. (3) Find a that is the angle between t and s.

FIG. 9 shows the octant of the phase surface plot of a biaxial crystal.

FIG. 10 shows the displacement of the image formed by the e-ray of a (45°, 0) cut YVO4 is visualized under a measuring microscope. The magnitude of the displacement d=L*tan(ρ), where ρ is the walk-off angle.

FIG. 11A shows the displacement of image formed by the e-ray of a (45°, 45°) cut YVO4 is visualized under a measuring microscope. The axial symmetry of the walk-off direction is evident.

FIG. 11B shows the difference in the shortening effect of the images due to their difference in respective refractive indices. One finds that nₑ>n₀˜2.

FIG. 12 illustrates plots of the two walk-off functions expressed by equations 1 and 2, respectively.

FIG. 13 shows that the walk-off is reversed in the second crystal by a 180° twist angle with respect to the beam axis.

FIG. 14 shows that the walk-off is reversed in the second crystal of 180° twist angle with respect to the beam axis.

FIG. 15 illustrates a measuring microscope for ZGP walk-off angle determination.

FIG. 16 shows the dimension and geometry of the single crystal ZGP AFB® with two GaP end caps.

FIG. 17 shows the double image of the letter F in (A) indicates the walk-off. The same image can be obtained by inserting a linear polarizer of 45° rotation with respect to crystallographic principal directions. The o-ray image in (C) and the e-ray image in (D) are displaced by a lateral distance of 0.162 mm.

FIG. 18 shows the configuration, dimensions, and geometry of AFB® 180° twist twins of ZGP.

FIG. 19 shows, in contrast to the images shown in FIG. 17, the images formed by transmitting 1550 nm light through two WOC ZGP composites A and B of same lengths show no double images caused by walk-off effect.

FIG. 20 shows: (A) the relative orientation and the geometry of the KTP samples are superimposed onto the phase surface plot; and (B) the phase front surface traces (i.e., one circle and one ellipse, respectively) on the XY plane. The angle, ρ, between two phase normals is the walk-off angle between the fast ray (1/nx) and the slow ray (1/nxy) of the Poynting vector P(90°, 23.5°).

FIG. 21 shows the beam walk-off effect, which becomes apparent when the blurry image becomes clear using a polarizer oriented in one of the principal axes as in (B), y or horizontal; and in (C), z or vertical axes, respectively. (Note: substantial astigmatism in nz direction).

FIG. 22 shows: (A) The six aligned KTP crystals augment the walk-off effect. (B) The magnitude and the direction of the walk-off are visualized through images formed through transmitting un-polarized light.

FIG. 23 shows Double images formed by beams transmitting through a biaxial crystal indicate the Poynting vector walk-off as shown in (A) when two KTP are aligned so the walk-off distance doubles. The walk-off disappeared for (B) of 180° twist twin arrangement. The walk-off of tilt 180° twin in (C) stays uncorrected. The walk-off of roll 180° twin (D) appears corrected due to the fact that most walk-off occurs in the horizontal component. The vertical component of the walk-off is not corrected.

FIG. 24 shows that the ray vector of a KTP(45.40) component intercepts at two points of the two traces of the phase surfaces. The radial distance of the two points correlates to the reciprocal of the refractive index of the fast ray and the reciprocal of the refractive index of the slow ray, respectively.

FIG. 25 shows the double images of a letter seen through the KTP(45,40) via a measuring microscope. The total displacement of two images correlates to the walk-off angle ρ.

FIG. 26 shows double images formed by both rays reduce to one image formed by the fast ray when the polarizer direction is rotated to the direction shown in (II) and to the image formed by the slow ray when the polarizer direction is rotated to the direction shown in (III).

FIG. 27 shows the images of an object formed by viewing through a pair of identical KTP (45,40) crystals arranged in four different ways: (I) aligned in the same orientation, (II) aligned in 180° twist twin configuration, (III) aligned in an 180° vertical flip twin configuration, and (IV) in an 180° horizontal flip twin configuration, respectively. Only (II) corrects walk-off completely.

FIG. 28 shows another way to completely correct walk-off is twist 90° after a 180° vertical flip. An alignment error of the cut crystal may have caused the twist angle to be slightly greater than 90°.

FIG. 29 is a schematic representation of the optical parametric generation process: The source beam (pump) of frequency ωp converts to component beams (idler and signal) of frequencies ωₛ and ωᵢ, respectively, via a nonlinear crystal.

FIG. 30 shows that given the length of the crystal and the walk-off angle, one finds that overlap volume of the two beams reduces along z.

FIG. 31 shows that the overlap energy volume decreases as the walk-off angle increases and as the length of the crystal increases for a the beam radius of 0.5 mm.

FIG. 32 shows that for a given walk-off angle (p=3° here), one finds that the overlap volume reduces as the radius of the beam decreases for a given length z of the NLO crystal component.

FIG. 33 shows the intensity profile of a Gaussian beam of 0.25 mm waist.

FIG. 34 shows a superposition of the spatial intensity distribution of the o-ray and the e-ray that walks off at ρ=3° at z =2 mm, 5 mm, and 10 mm, respectively.

FIG. 35 shows that the energy overlap drops off progressively along z for a given walk-off angle. At a specific distance, the overlap drops off sharply as the walk-off angle increases.

FIG. 36 shows that as the walk-off angle increases, one finds that the drop off in total energy overlap accelerates.

FIG. 37 shows that walk-off makes the displaced beam deviate from a stable resonant condition in a folded confocal cavity.

FIG. 38 shows that the walk-off corrected nonlinear crystal arrangement will satisfy resonant condition in a folded confocal cavity.

FIG. 39 (Appendix A) shows phase matching conditions.

FIG. 40 (Appendix A) shows that the function Dk ₍₎ becomes zero when propagating waves are at a specific angle.

FIG. 41 (Appendix A) shows the phase matching angle θₚₘ plotted against the signal wavelength, λs, in nm.

FIG. 42 (Appendix A) shows that deduced from the type I ooe configuration, one finds that walk-off is a function of θ: Walk-off diminishes as θ approaches 0 or 90. The symmetry axis is at θ=90. For θ=67.03, one finds that the walk-off is close to the maximum value for lithium niobate. The walk-off angle at θ=67.03 is 1.29 degree.

### DETAILED DESCRIPTION OF THE INVENTION

The present invention provides walk-off corrected (WOC) non-linear optical (NLO) components, devices and systems including one or more engineered WOC NLO crystal doublets. Such systems and devices advantageously increase the efficiency of an OPO operation. Devices are applicable to any uniaxial and biaxial NLO crystals in a wide range of wavelengths, e.g., from far ultraviolet to visible to far infrared. Devices employing engineered WOC NLO components according to embodiments of the present invention include any conventional frequency converting architectures. Systems and methods are also provided to unambiguously determine and correct walk-off for any arbitrary uniaxial and biaxial crystal orientation. The correct crystal orientation is also experimentally confirmed. This allows the use of WOC crystal doublet assemblies for a wide range of wavelengths and NLO crystals that until now have not been used because of low efficiency due to walk-off and inability of readily correcting walk-off.
Design Calculations of Walk-off

Coherent scatter of electromagnetic waves at the material boundary separating two media is described by Fresnel's law of reflection and refraction and by Snell's law. When the media are isotropic, the laws that govern the phenomenon are simple. When one of the media is anisotropic, one has to take into account interaction between the polarization directions of the propagating fields and the lattice orientations of the crystallographic structure.

A cubic single crystal (a=a₁=a₂=a₃) is optically isotropic and has a unique refractive index for a given temperature. It behaves like glass or any other isotropic material. Tetragonal (a₁=a₂≠a₃), trigonal (rhombohedral) (a₁=a₂=a₃≠c) and hexagonal (a₁=a₂=a₃≠c) single crystals are optically uniaxial materials. Each of them consists of two principal refractive indices, namely nₒ for the ordinary ray (o-ray) and nₑ for the extra-ordinary ray (e-ray), respectively. All of the other crystals are optically biaxial materials that have three principal refractive indices with respect to the polarization directions of the propagating electromagnetic waves.

Walk-Off Angle of Uniaxial Crystals

The refractive index of the e-ray of any anisotropic material is not unique. It is a function of θ and its value resides within an interval bounded by the values of nₒ and nₑ, respectively.

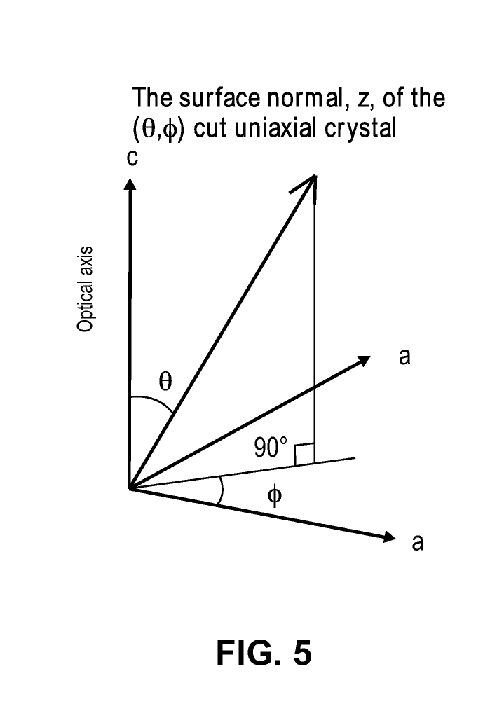

Walk-off of the e-ray propagating in a non-principal direction in a uniaxial crystal occurs when the phase-normal and the Pointing vector of the beam are not collinear. The magnitude and the direction of the beam walk-off in a uniaxial single crystal directly correlate to the level of birefringence with respect to θ that defines the propagating direction of the electromagnetic wave. To find the walk-off angle function one starts with construction of a coordinate system (shown in FIG. 5) that effectively describes both the optical parameters and the crystallographic structure of the system via symmetry arguments.

A randomly polarized beam that propagates through a uniaxial single crystal will in general spontaneously decompose into two beams. One is the ordinary ray and the other is the extraordinary ray. The phase fronts of the two beams can deviate from each other in propagating speeds as well as in propagating directions. The difference in propagating speed between the two can be illustrated by the indicatrix of the crystal. Beam walk-off occurs only when the beam propagating angle θ≠0 or ≠π/2. The refractive index of the extraordinary ray, n(θ), of a uniaxial single crystal is a function of the relative propagating direction of the beam with respect to the optical axis. The variation of the refractive index of the e-ray can be expressed by the following equation:

1/n²(θ)=cos ²θ/(nₒ²)+sin ²θ/nₑ²

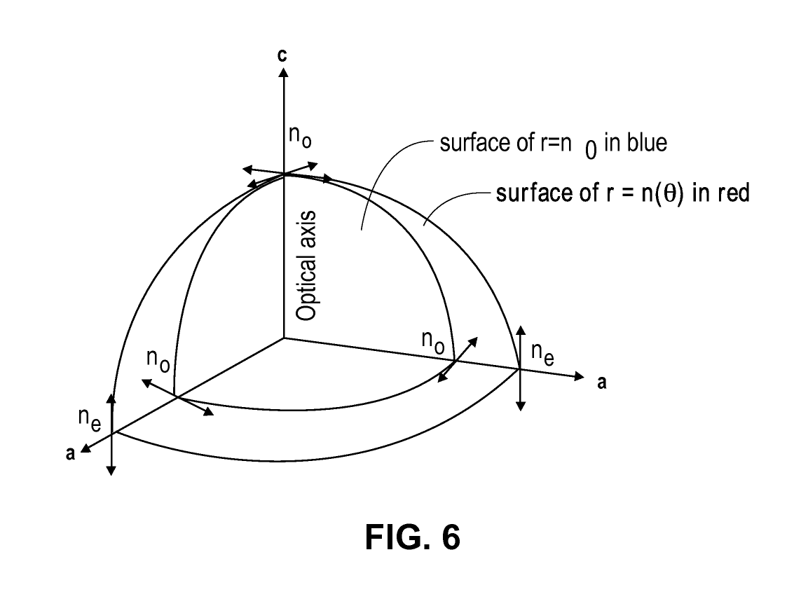

With this equation, one can construct the optical indicatrix shown in FIG. 6.

The angular deviation in phase front normal directions between e-ray and o-ray manifests the displacement of the two beams after emerging from a parallel (θ, φ) cut uniaxial single crystal component of the uniaxial crystal. One can find the angular deviation of the two phase front normals using geometrical arguments.

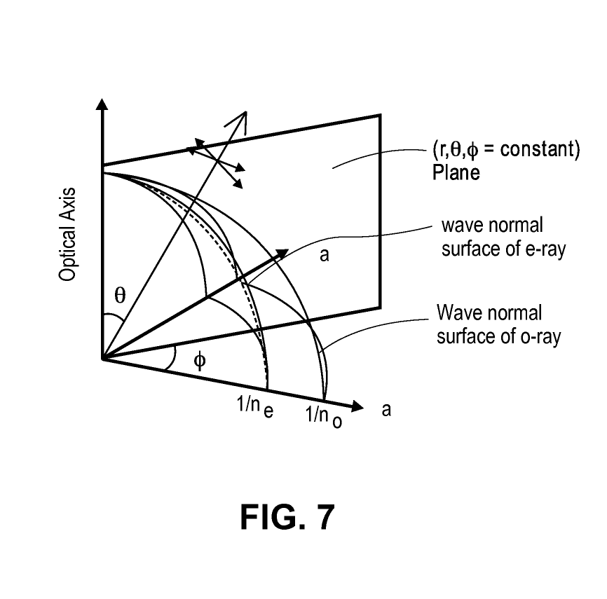

One constructs a unit wave normal surface of a uniaxial crystal by inverting the value of the optical indicatrix. The spherical wave normal surface of the o-ray will be included in the ellipsoid wave normal surface with the rotational symmetry about the c-axis preserved. FIG. 7 shows an octant of the surfaces.

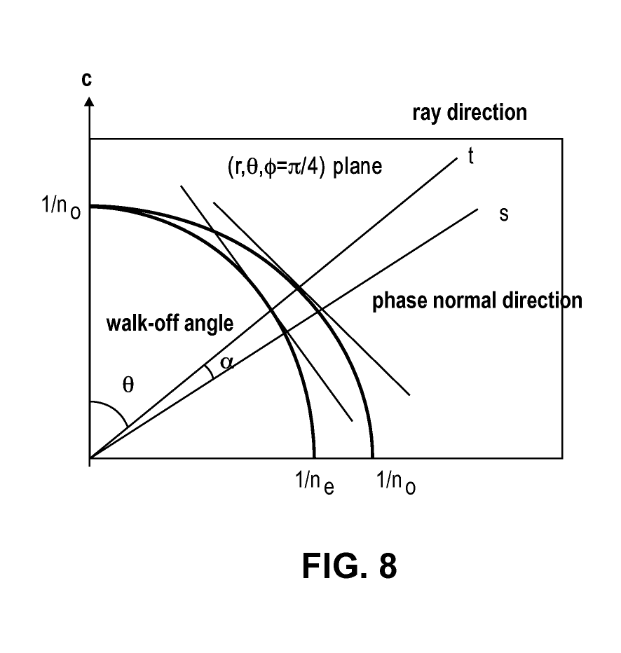

Since the surfaces are axially symmetrical, one considers only intersecting traces of the two surfaces with the plane (r, θ, φ=a constant) as shown in FIG. 8.

One derives the phase normal direction by superimposing the ray direction that passes through the origin onto the ray surfaces. Then, one draws a tangent line passing the intersection between the e-ray surface and the ray direction. Drawing a normal line from the origin to the tangent line just drawn, one finds the phase normal direction that is the e-ray direction within the crystal. The discrepancy between o-ray phase normal (that coincides with the ray direction) and e-ray phase normal is the walk-off angle, α, which is expressed by the following equation (Eqn. 1):

$$φ ( γ , λ ) := - a tan [ \frac{\begin{matrix}y 0 ( γ , λ ) x 0 ( γ , λ ) - \\ \sqrt{\begin{matrix}\begin{matrix}{( y 0 ( γ , λ ) \cdot x 0 ( γ , λ ) )}^{2} - \\ ( {b ( λ )}^{2} - x 0 {( γ , λ )}^{2} ) \cdot \end{matrix} \\ ( {a ( λ )}^{2} - y 0 {( γ , λ )}^{2} )\end{matrix}}\end{matrix}}{{( x 0 ( γ , λ ) )}^{2} - {b ( λ )}^{2}} ] + a tan ( \frac{\begin{matrix}yy 0 ( γ , λ ) xx 0 ( γ , λ ) - a ( λ ) \cdot \\ \sqrt{\begin{matrix}\begin{matrix}xx 0 {( γ , λ )}^{2} + \\ yy 0 {( γ , λ )}^{2} -\end{matrix} \\ {a ( λ )}^{2}\end{matrix}}\end{matrix}}{xx 0 {( γ , λ )}^{2} - {a ( λ )}^{2}} )$$

Both rays emerge with the same propagating direction after transmitting through the crystal, only with apparent parallel displacement of the e-ray with respect to the o-ray.

ZGP is a tetragonal crystal of class 42 m. Consequently, it is optically a positive uniaxial material (nₑ>nₒ). Walk-off is a concern when a critical-phase-matching scheme is used for OPO applications. It is difficult to actually observe the walk-off effect in ZGP due to two factors: one is that the ZGP transmits little in the visible and other convenient wavelengths; the second is that the walk-off effect is small due to smaller birefringence of the crystal.
Walk-Off in Biaxial Crystals

Some of the walk-off characteristics of biaxial crystals are the following: (1) there is no walk-off for the ray vectors that are parallel to any one of the principal axes, (2) walk-off angles can be calculated using similar equations for calculating the walk-off in uniaxial crystals for ray directions that are located in one of the three principal planes, XY, YZ, and XZ, respectively.

There is no easy way to calculate the walk-off angle for the general ray vector transmitting through a biaxial crystal. However, one can use a similar geometrical argument as for obtaining walk-off angles in uniaxial crystals. One expects to obtain the absolute as well as the relative walk-off angles of initially collinear beams of different polarizations and/or of different wavelengths. The essence of the methodology is not different from the formal derivation given in some of the publications but appears more accessible conceptually.

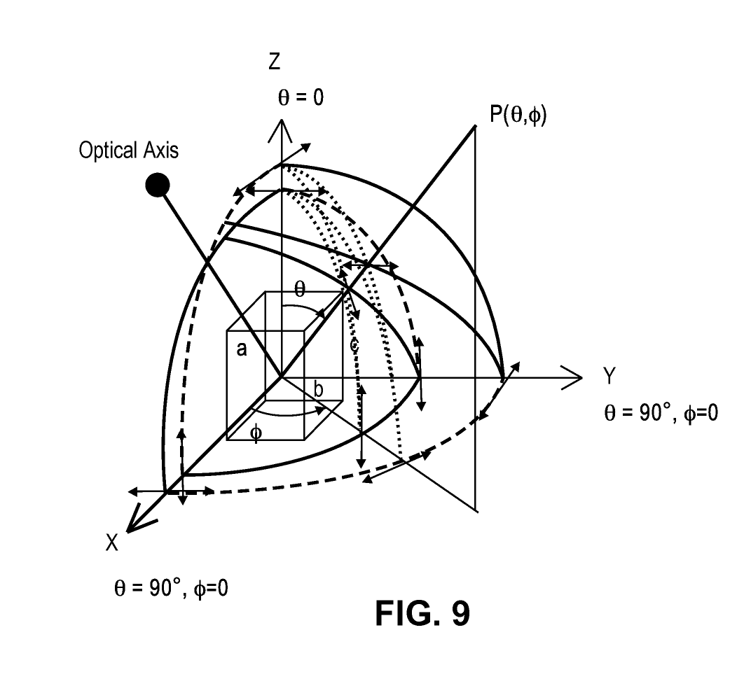

The walk-off angle of two differently cut KTP components has been measured to confirm the validity of the walk-off calculations. ( i ) θ=90° and φ=23.5° cut KTP has been used first as a prototype because it is readily available. The calculation of walk-off angle for θ=90° and φ=23.5° cut KTP is not general, since the ray vector lies in the XY plane. The same method used for a uniaxial crystal can be applied to calculate the walk-off angle in this case. The calculated walk-off angle is 0.26°. ( ii ) Then, a more general cut of KTP of θ=45° and φ=40° has been considered as a second prototype for finding its walk-off angle. An octant of a phase surface plot of a biaxial crystal is shown in FIG. 9.

The random P(θ, φ) can be in each of the three planes, PX, PY, and PZ, respectively. The traces of intersection between the phase surface and one of the three planes are a pair of ellipses. Finding tangent lines at the intersecting points of P(θ, φ) with each of the two ellipses will allow one to find the angle deviation between the phase normal and the ray directions in each of the three profiles (i.e., PX, PY, and PZ, respectively). The vector sum of the three deviation angles will be the relative walk-off angle between the two relevant vectors. Measurement of walk-off and experimental confirmation of WOC for crystal pairs

The following experimental procedures serve as a demonstration of the technique of determining the walk-off angle of a supplied crystal, and thereby at least approximately checking the accuracy of the crystal orientation. It also is employed for orienting two crystal pairs with respect to each other to make a WOC pair.
YVO4

YVO4 is not a NLO crystal but it is uniaxial and therefore also experiences beam walk-off in analogy to ZGP. Precut YVO4 single crystals have been used as a prototype for studying the walk-off effect on positive uniaxial crystals in general. Two types of θ=45° cut YVO4 single crystals, φ=0° and φ=45°, respectively, of the following dimension were available (Table 1):

TABLE 1
Dimensions of YVO4 single crystals

| YVO₄ SC | X, [mm] | Y, [mm] | L, [mm] | θ, [°] | φ, [°] |
|---|---|---|---|---|---|
| #1-1 | 2.63 | 2.63 | 14.98 | 45 | 0 |
| #1-2 | 2.63 | 2.63 | 14.98 | 45 | 0 |
| #2-1 | 2.63 | 2.58 | 15 | 45 | 45 |
| #2-2 | 2.64 | 2.59 | 15 | 45 | 45 |

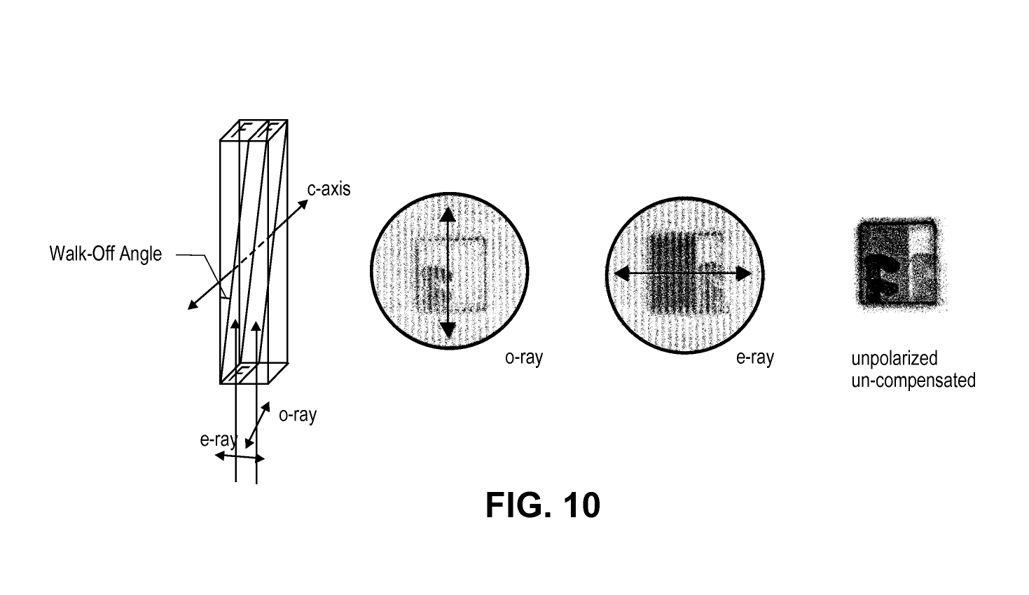

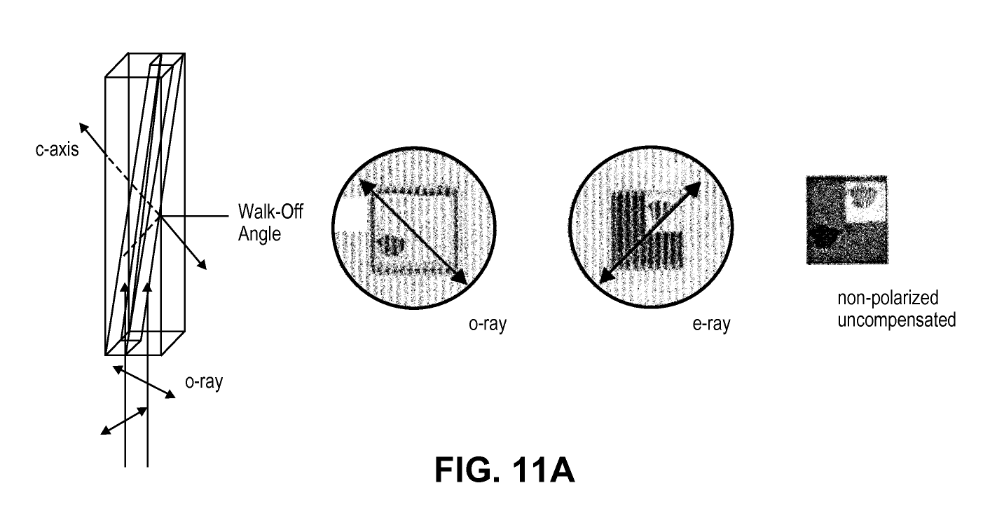

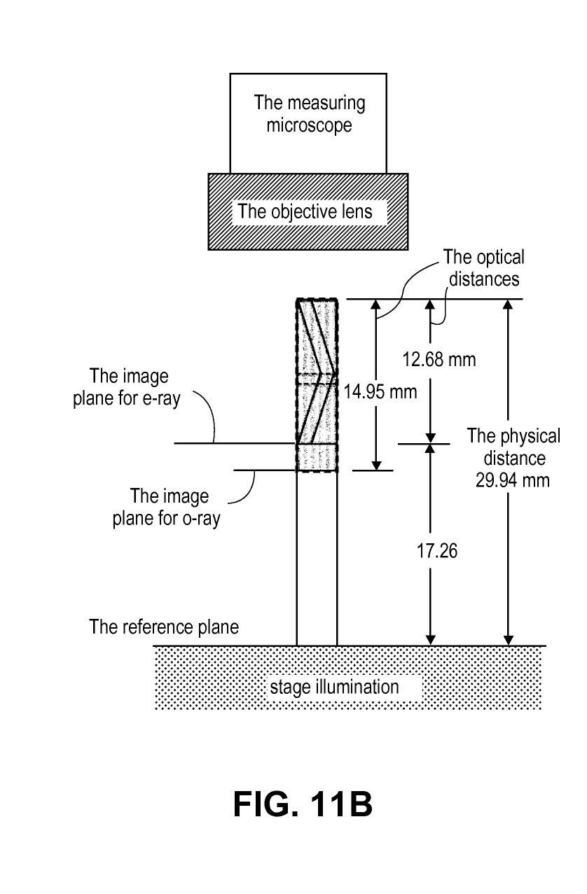

The problem is simplified by using the crystals cut in directions specified by (θ, φ) with respect to the principal directions. Therefore, only normal incident beams are considered to avoid complications introduced by diffraction. As show in FIG. 10, the ray paths of a (45°, 0) cut uniaxial single crystal are shown, and in FIG. 11A the ray paths of a (45°, 45°) cut uniaxial single crystal are illustrated. The normal incident beams with respect to the z plane of (θ, φ) cut uniaxial single crystal will have a lateral displacement between e-ray and o-ray at the exit plane (-z). The magnitude of the displacement is L*tan (ρ) and the direction will be θ+ρ, where ρ is the walk-off angle. As shown in FIG. 11B, a measuring microscope determines the distance between the image formed by the o-ray and the image of the same object formed by the e-ray transmitting through the YVO4 single crystals along the z direction. The double images are visualized by photos shown in FIG. 10 and FIG. 11A. They confirm that the displacement vectors are axially symmetric for the given θ. The measured data are listed in Table 2.

TABLE 2
Measured walk-off angle of four samples

| YVO₄ SC | X, [mm] | Y, [mm] | L, [mm] | θ, [°] | φ, [°] | Δx | Δy | Δl | W_{θ}, [°] |
|---|---|---|---|---|---|---|---|---|---|
| #1-1 | 2.63 | 2.63 | 14.98 | 45 | 0 | 1.595 | 0.000 | 1.595 | 6.08 |
| #1-2 | 2.63 | 2.63 | 14.98 | 45 | 0 | 1.600 | 0.000 | 1.600 | 6.10 |
| #2-1 | 2.63 | 2.58 | 15 | 45 | 45 | 1.143 | 1.126 | 1.605 | 6.11 |
| #2-2 | 2.64 | 2.59 | 15 | 45 | 45 | 1.128 | 1.113 | 1.585 | 6.03 |
| | | | | | | | | AVE: | 6.08 |
| | | | | | | | | STDEV: | 0.03 |

The image distance in the z-direction is measured to confirm the refractive index discrepancy between the e-ray and o-ray. The difference in heights of the image planes correlates to the magnitude of the birefringence (Δn) along the viewing direction. FIG. 11B depicts the effect schematically.

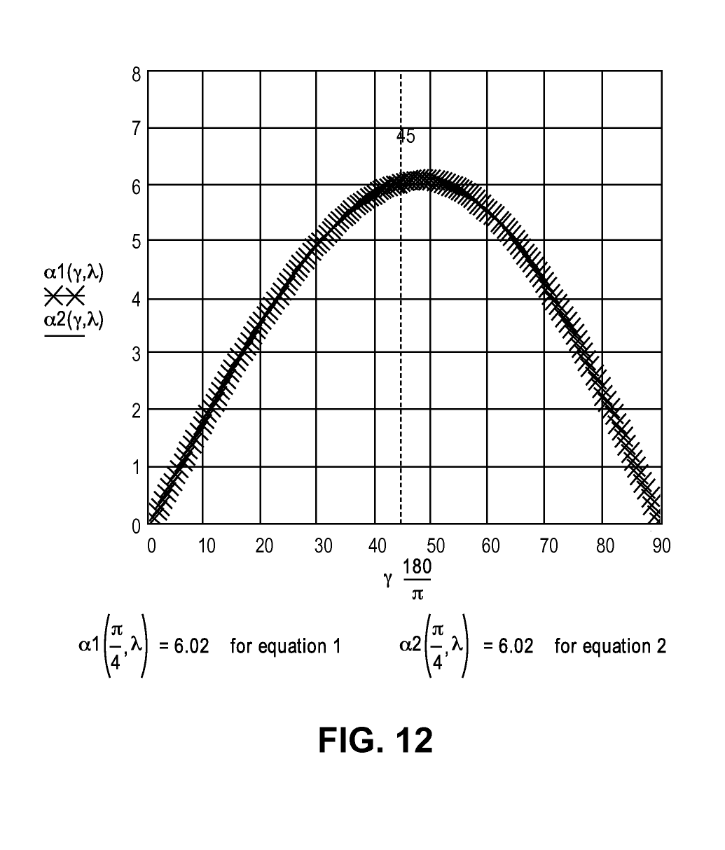

A comparison among equations that express the walk-off functions by plotting them on the same coordinates is made and shown in FIG. 12. Equation 1 is derived from the geometrical argument discussed above, and compared with an equation given in “Handbook of Nonlinear Optics” by R. S. Sutherland on p. 89. The calculated results for equation 1 and a published equation are identical. For 45° cut YVO4 crystals, the walk-off angles are calculated as shown in FIG. 12.

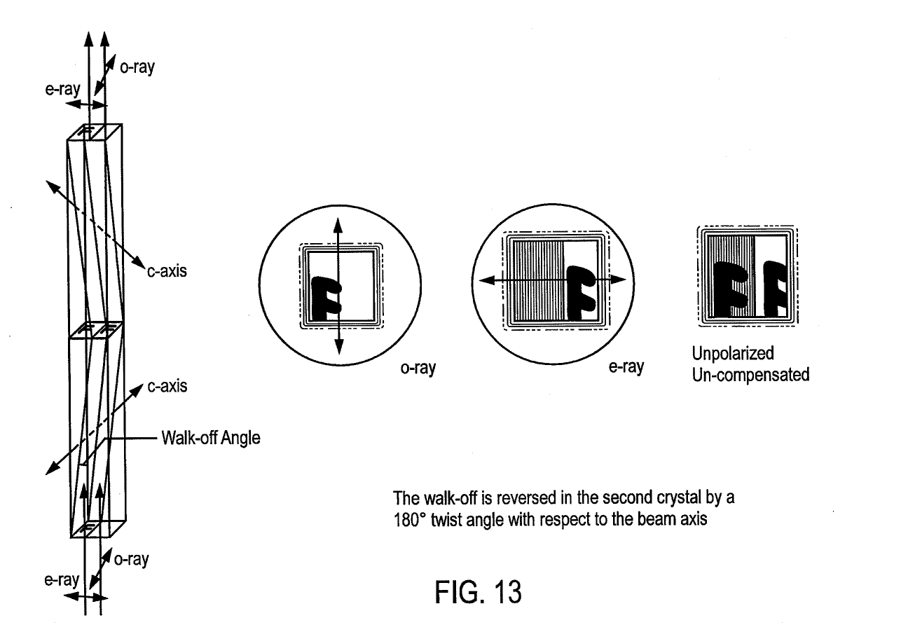

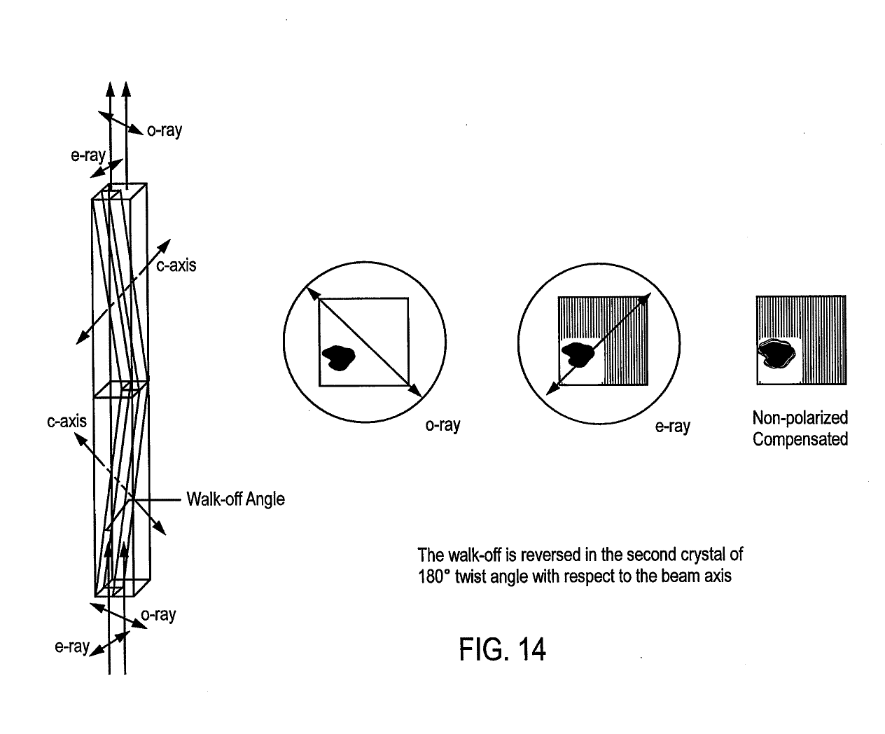

The direction and the magnitude of the walk-off effect have thus been determined by the use of a measuring microscope. The correction of walk-off is helped by a symmetry argument. The methodology for walk-off compensation relies on using the axial symmetrical property of the crystal. It is found that performing a 180° twist at the crystal boundary of two otherwise identical uniaxial single crystals will allow the walk-off of the e-beam to be reversed. This technique is experimentally validated as illustrated in FIGS. 13 and 14.

Using the same geometrical argument for calculating the walk-off angle as a function of θ, it is desirable to validate the alignment procedure of crystal pairs by demonstrating consistency between calculated and experimentally measured walk-off angle of a θ=55° cut ZGP crystal. The calculated walk-off angle is 0.65° in this case.

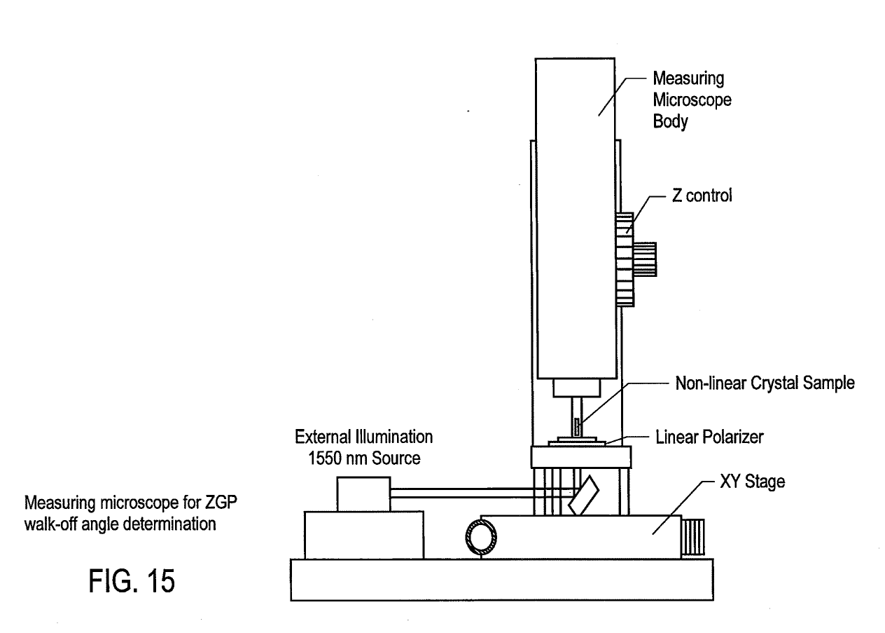

Laser-damaged, θ=55° cut ZGP single crystals have been used as specimens for bonding and for walk-off correction experiments. One AFB® GaP/ZGP/GaP composite and two 180° twist twin ZGP/ZGP composites were prepared for this purpose. Since ZGP single crystals transmit insufficient visible light to observe the walk-off using a measuring microscope, one needs an illumination source in the transparent wavelength range of ZGP. A useful measuring setup constructed using a 1550 nm laser as illumination source is shown in FIG. 15. ZGP, cut with a specific angle θ, is placed on a stage with a linear polarizer and an object to be imaged through the crystal. The entrance and exit surfaces of the crystal are polished smooth and parallel. Since ink previously used for YVO₄ samples became transparent at 1550 nm, a letter F has been scribed onto the top surface of a glass plate that is used as the sample carrier plate. The image of the marker, the letter F, would be visible upon 1550 nm laser beam illumination. The walk-off effect would be displayed as double images of a definite lateral displacement (d) for a given length (L) of the crystal. The walk-off angle was then calculated by the following formula:

ρ=arctan(d/L).

The polarization directions that form each of the two images have been determined by rotating the linear polarizer about the optical axis until only one clear image occurred. By adjusting the z-travel, the image was brought to a sharp focus. By registering the z travel distance from the image plane of the top surface, the refractive index was estimated at the illuminating wavelength. Two mutually orthogonal rotation angles were found that formed sharp images. One was parallel to o-ray polarization and the other was parallel to the e-ray polarization.

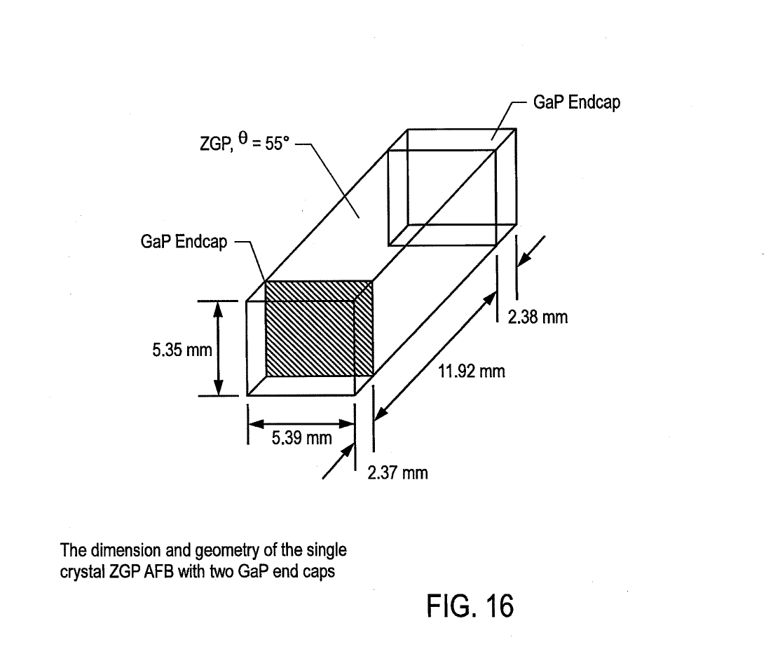

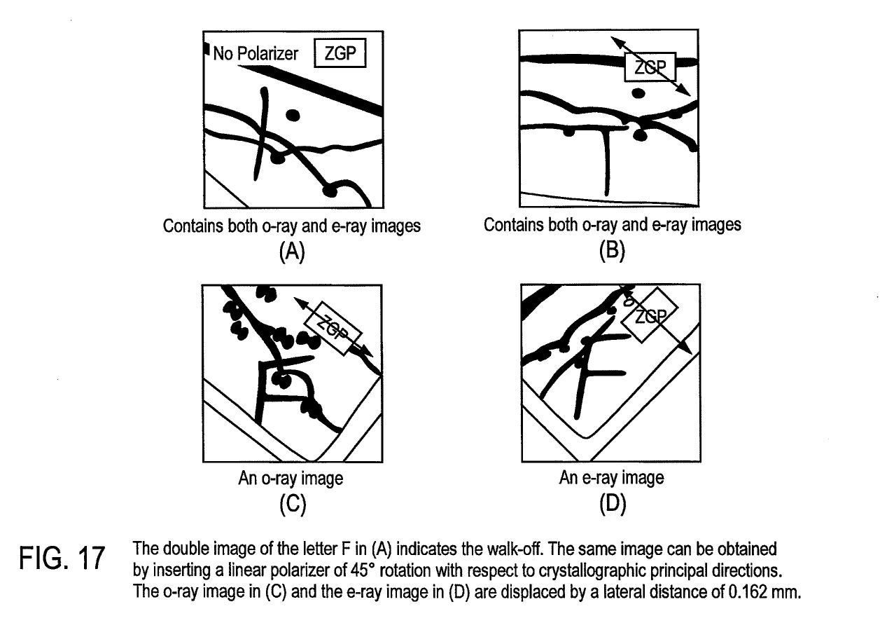

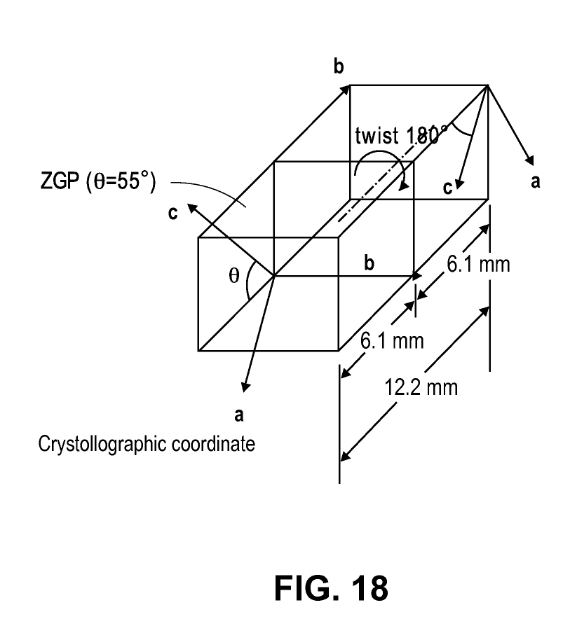

The dimension and geometry of a walk-off uncorrected ZGP sample is shown schematically in FIG. 16. The resultant photos are shown in FIG. 17. The walk-off angle, ρ, is the arctan(0.162/11.92)=0.66°, which is in a good agreement with the calculated ρ that equals 0.65°. An estimate of the nominal n(ZGP) at 1550 nm yielded 3.18. The configuration of two WOC AFB® 180° twin ZGP composites is shown in FIG. 18.

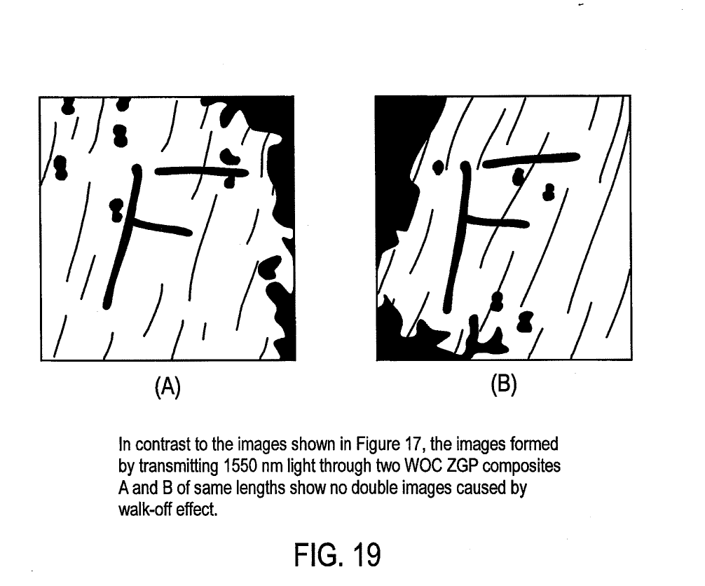

Employing the measurement setup shown in FIG. 15, two WOC images of two composites, respectively, are obtained, as shown in FIG. 19. Therefore, WOC ZGP doublets have been demonstrated and confirmed optically.
KTP

(i) θ=90°, φ=23.5°

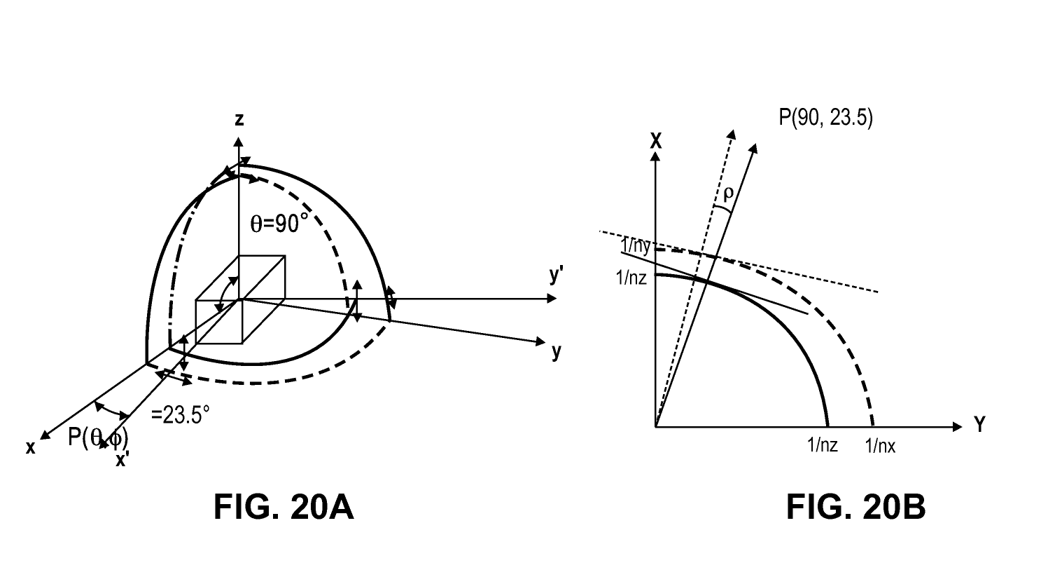

Walk-off and walk-off correction effects have been observed with six KTP with θ=90° and φ=23.5° single crystals of dimension 3×3×5 mm and the 3×3 mm faces are normal to P(90°, 23.5°) (see FIG. 20).

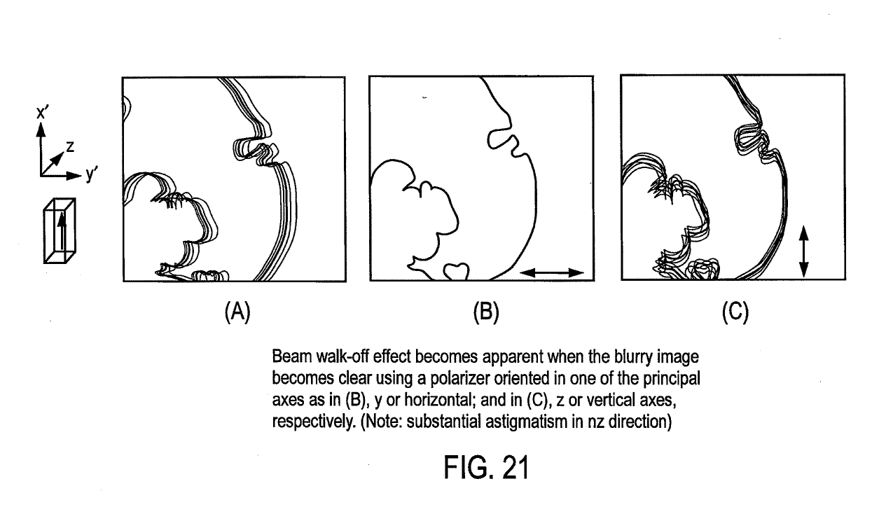

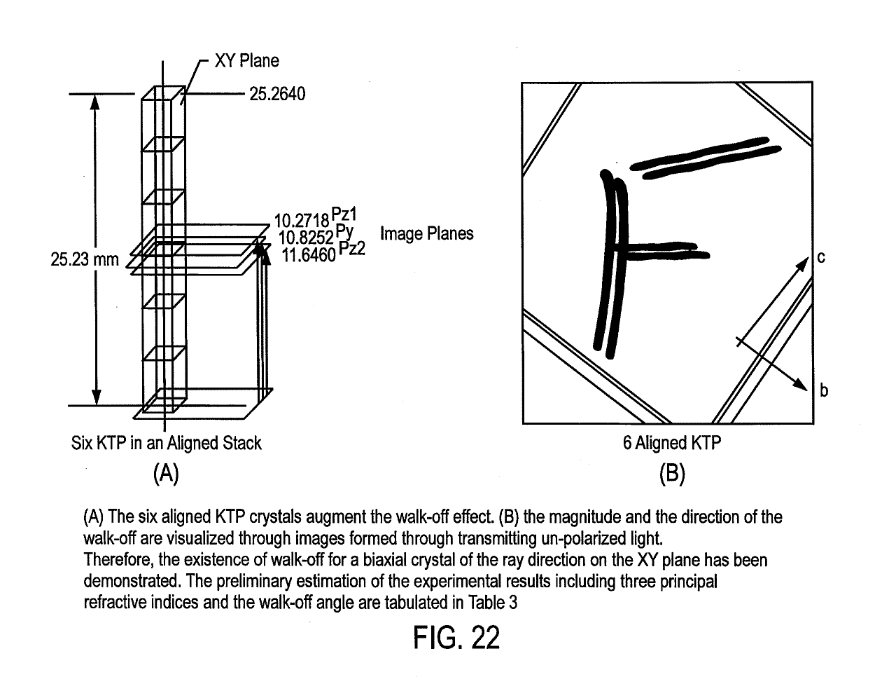

Since KTP is transparent at visible wavelengths, images may readily be obtained with a measuring microscope. Some of the resultant images transmitting through the sample are shown in photos in FIG. 21. To reconfirm the walk-off angle and the displacement direction, a stack of aligned KTP crystals of the same cut is arranged for observation (as shown in FIG. 22A). Therefore, the existence of walk-off for a biaxial crystal of the ray direction on the XY plane has been demonstrated. The preliminary estimation of the experimental results including three principal refractive indices and the walk-off angle are tabulated in Table 3.

TABLE 3
Comparison between measured and calculated principal
refractive indices and walk-off of KTP (90, 23.5)

| | measured | calculated |
|---|---|---|
| n_{z} | 1.91 | 1.89 |
| n_{y} | 1.76 | 1.79 |
| nₓ | 1.72 | 1.78 |
| ρ, [°] | 0.24 | 0.26 |

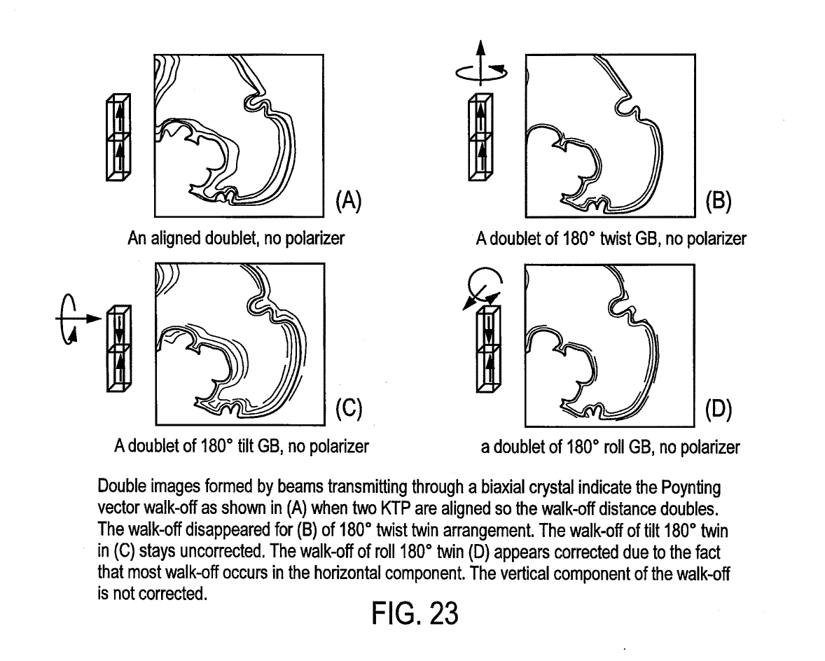

It is concluded that walk-off may be corrected by bonding a pair of twist 180° twins of the given cut biaxial KTP crystals. When a pair of KTP samples is arranged in various 180° rotation twins, it is found that the proper relative bonding orientation for walk-off correction is unique for a general cut of the crystal. Some of the results are shown in photos of FIG. 23.

(ii) Investigation of Walk-Off Angle for a General Cut of a Biaxial Crystal (KTP θ=45°, φ=40°)

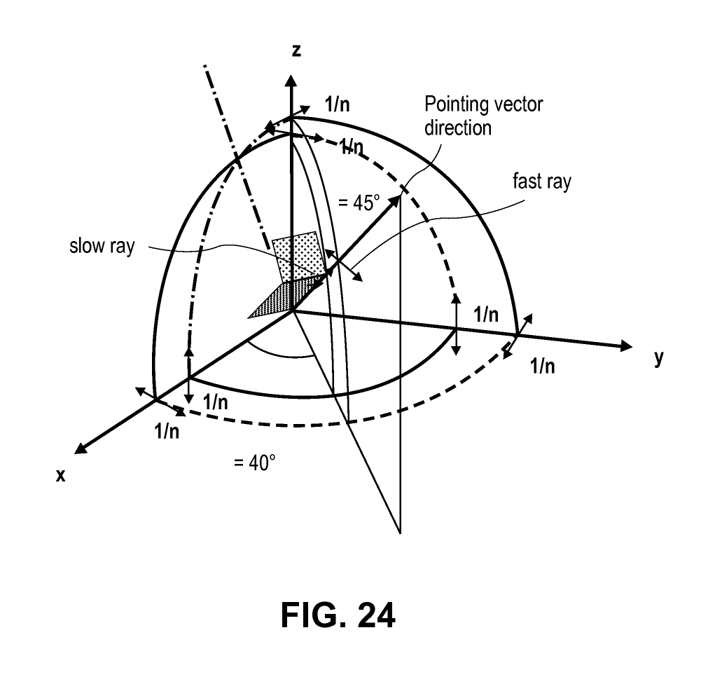

To demonstrate that the twist 1800 twin corrects walk-off in any orientation, KTP single crystals cut at θ=45° and φ=40° are chosen as the prototype for proof of principle. The relative orientation of the geometry of the KTP (45,40) component with respect to the principal coordinates of the crystal structure is shown schematically in FIG. 24. Super-imposed is the phase surface plot with respect to the ray directions.

The walk-off angle between the fast ray and the slow ray can be calculated using the following equation:

$$tan ( ρ ) = {n}^{2} \sqrt{\begin{matrix}{( \frac{{s}_{x}}{1 / {n}^{2} - 1 / {n}_{x}^{2}} )}^{2} + ( \frac{{s}_{y}}{1 / {n}^{2} - 1 / {n}_{y}^{2}} ) + \\ {( \frac{{s}_{z}}{1 / {n}^{2} - 1 / {n}_{z}^{2}} )}^{2}\end{matrix}}$$

where:
sₓ=sin (θ)* cos (Φ)
s_{y}=sin (θ)* sin (Φ)

### S_{z}=cos (θ)

The value of n will be one of the two roots of the following equation.

$$\frac{{s}_{x}^{2}}{1 / {n}^{2} - 1 / {n}_{x}^{2}} + \frac{{s}_{y}^{2}}{1 / {n}^{2} - 1 / {n}_{y}^{2}} + \frac{{s}_{z}^{2}}{1 / {n}^{2} - 1 / {n}_{z}^{2}} = 0$$

The two roots of n are denoted n_{fast} and n_{slow}. For visible wavelengths, n_{fast}=1.781, and n_{slow}=1.829, respectively. Then the walk-off angle is calculated, yielding 3.27° for the slow ray and 0.52° for the fast ray. The relative walk-off between the two would be 3.31°.

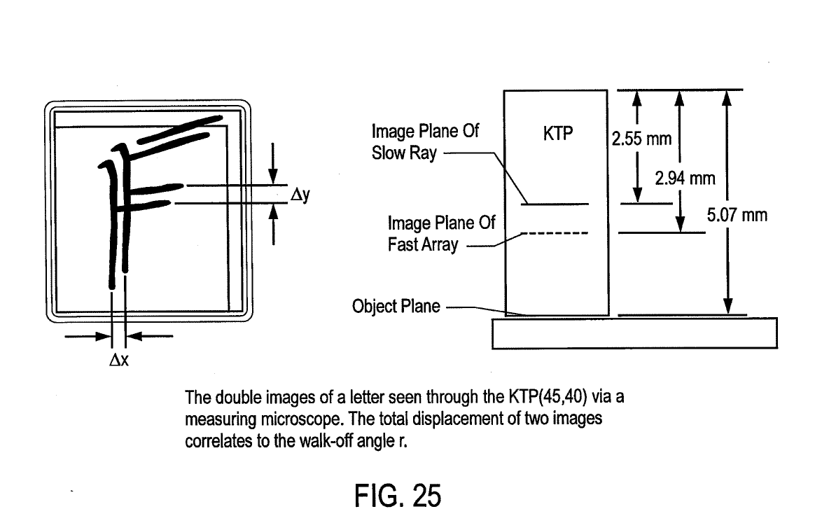

This value is now be confirmed experimentally. The approximate refractive indices are deduced by finding the length ratio between real object and the image of the same crystal using a measuring microscope. Then, the walk-off angle is calculated by measuring the relative displacement of the two images (one is formed by the fast ray and the other is formed by the slow ray). A typical image is shown in FIG. 25. The measurement results are listed in Table 4.

TABLE 4
Experimental determination of walk-off angle

| | |
|---|---|
| KTP | θ = 45°, φ = 40 cut |

| | | |
|---|---|---|
| thickness, [mm] | 5.07 | ρ, [°] |
| Δx | 0.226 | 2.550 |
| Δy | 0.188 | 2.121 |

| | |
|---|---|
| relative ρ | 3.317 |

| | | image | |
|---|---|---|---|
| | length | length | n |
| n_{fast} | 5.07 | 2.94 | 1.73 |
| n_{slow} | 5.07 | 2.55 | 1.99 |

To characterize the walk-off, one wants to identify the polarization direction of the two beams as well as their direction of walk-off. The directions of the image displacements and the discrepancy in focal distances of the images provide verifiable evidence for walk-off compensation arrangements.

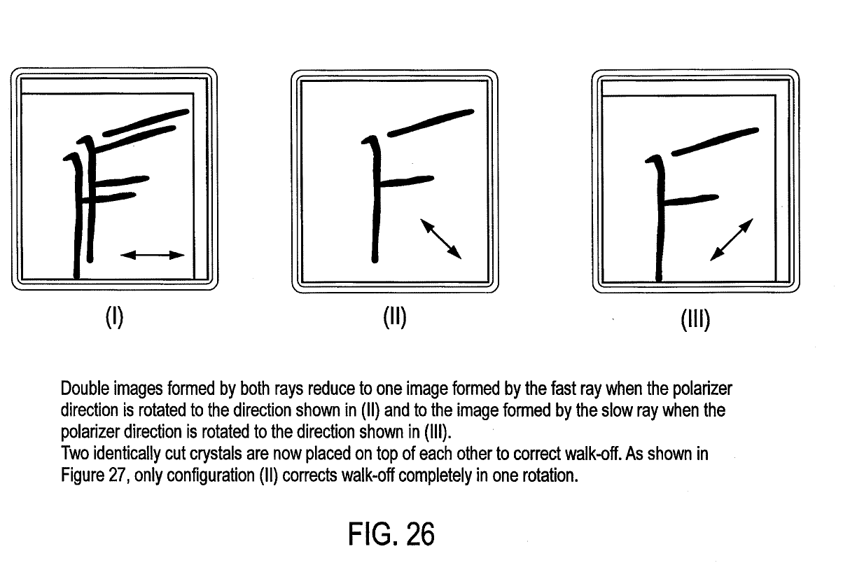

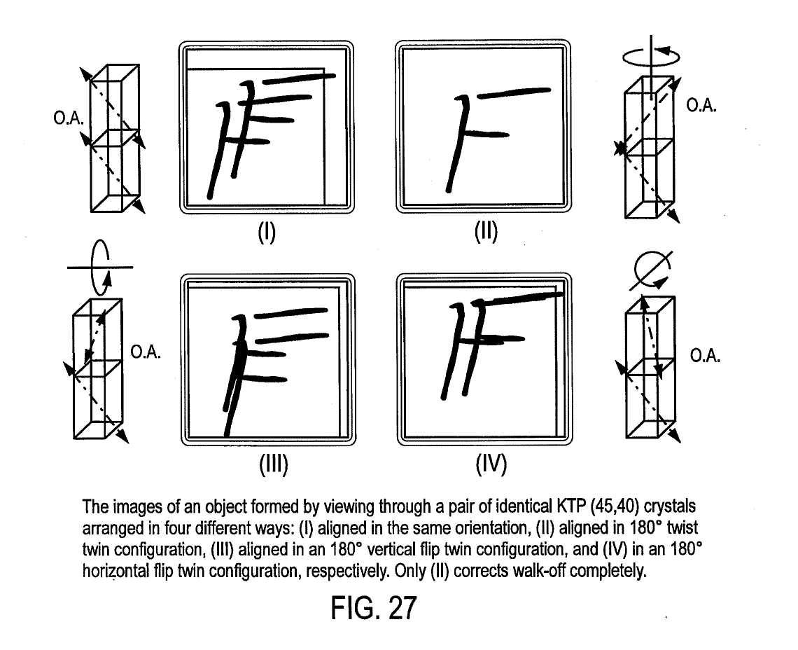

Inserting a linear polarizer between the illuminating source and the object results in the photos shown in FIG. 26. Two identically cut crystals are now placed on top of each other to correct walk-off. As shown in FIG. 27, only configuration (II) corrects walk-off completely in one rotation.

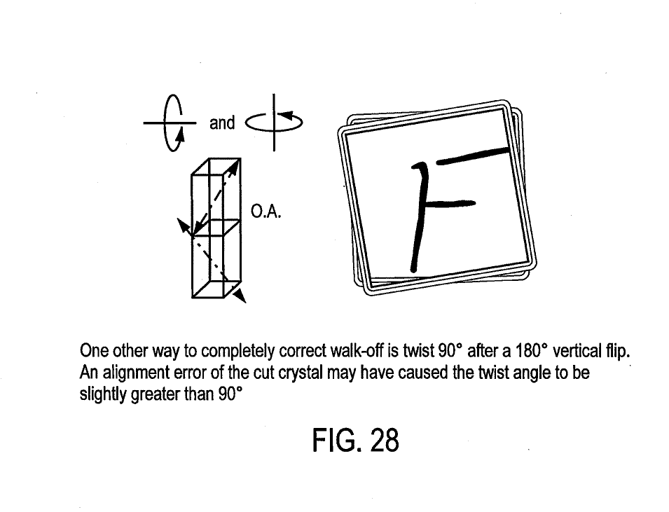

Another configuration also corrects walk-off completely. Nonetheless, it involves more than one rotation steps. The photo in FIG. 28 shows the complete walk-off correction with a 180° vertical flip followed by an 90+° CCW twist.

Walk-off For Gaussian Beams

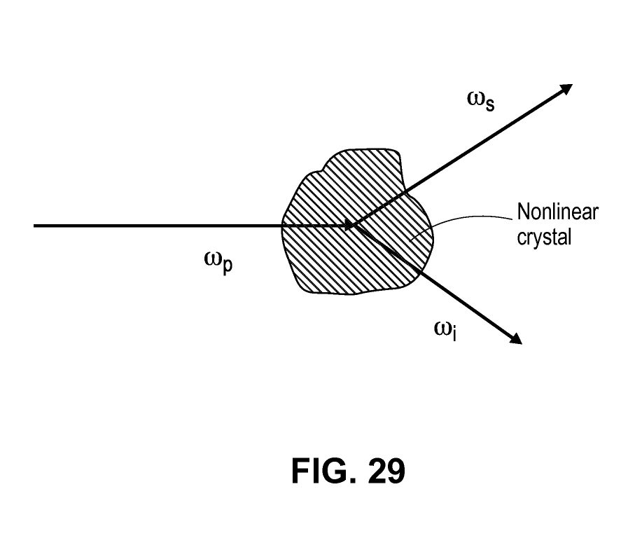

Optical parametric generation can be considered as an energy redistribution process. The source beam transfers energy to its parametric components via nonlinearity of the propagating medium. Throughout the conversion process, the energy and momentum remain conserved. FIG. 29 is a schematic representation of the optical parametric generation process.

Physical overlap between modes is necessary for energy transfer. The walk-off effect diminishes the overlap volume of propagating modes so the efficiency of the conversion is reduced. Since the nonlinear effect is a high field effect, one cannot achieve both a high intensity narrowly collimated beam and maintain the overlap for a given pump power when walk-off exists. The walk-off effect is one of the critical factors that affect the conversion efficiency.

Between laser damage limits for an intense beam and the threshold required for conversion, one finds that increasing overlap volume by walk-off correction becomes a desirable solution to the problem. A comprehensive design optimization can be achieved by varying periodically the lengths of 180° twist twins. The optimized length of twins will allow the overlap volume to stay above a certain level for achieving high conversion efficiency. Furthermore, the walk-off effect has limited the ranges of wavelengths that can be generated using existing OPO schemes. Once the walk-off becomes correctable, it advantageously opens doors to widen the attainable wavelengths ranges of existing OPO technology.

Conservation of energy demands that ωₚ=ωᵢ+ωᵢ. The frequencies of the pairs of the generated beams are not unique. They consist of a continuum of infinite pairs that satisfy the energy and momentum conservation. Nonetheless, the effect of the generation for a specific pair depends on at least two conditions: one is the match of the phase fronts, and the second is a sufficient magnitude of the second order nonlinear coefficients. Both conditions directly relate to the characteristics of the nonlinear propagating medium.

The connotation of a nonlinear medium implies a finite nonlinear coefficient, dᵢⱼ. However, the magnitude of dᵢⱼ is propagating direction dependent. One needs to know the non-vanishing nonlinear coefficients that reflect the symmetry of the crystal structure of the nonlinear media. The effective d value (denoted d_{eff}) depends also on the type of angle phase matching applied in addition to the propagating direction specified by θ and φ with respect to the orientation of the crystal. For example: The d_{eff} of ZGP (crystal class 42 m) for phase matching beams, being one of ooe, oeo, and eoo configurations, is expressed as d_{eff}=−d₁₄ sin (θ) sin (2φ), and the d_{eff} of the phase matching beams, being one of the eeo, eoe, and oee configurations, is expressed as d_{eff}=d₁₄ sin (2θ) cos (2φ). The formula for finding the value of d_{eff} of a biaxial crystal becomes substantially more complicated than those of a uniaxial crystal but is still available. For instance, d_{eff} for KTP (mm2) of type I phase matching is

(d₃₂−d₃₁)(3 sin ²(δ)−1) sin (θ) cos (θ) sin (2φ) cos d−3(d₃₁ cos ²(φ)+d₃₂ sin ²(φ)) sin (θ) cos ²(θ) sin (δ) cos ²(δ)+(d₃₁ sin ²(φ)+d₃₂ cos ²(φ)) sin (θ) sin (δ)(3 sin ²δ−2)+d₃₃ sin ³θ sin δ. cos ²δ,

where δ is defined by cot (2δ)=( cot ²(Ω) sin ²(θ)−cos ²(θ) cos ²(φ)+sin ²(φ)/ cos (θ)−sin ²(φ), and
where Ω is the polar angle of the optical axes. A similarly complicated equation gives the d_{eff} for type II phase matching.

Phase matching between generated beams and the source beam enhances the energy transfer efficiency. Non-critical and critical angle phase match conditions for optical parametric generation are the main topics of nonlinear optics. The framework and solution for finding phase match conditions has been addressed in textbooks and in the published literature. One of the practical constraints for implementing the critical angle phase match condition for optical parametric generation is to avoid or to lessen the birefringence induced walk-off effect in nonlinear crystals.

The disadvantages of the walk-off effect are many. It limits the possible tuning range of the optic parametric generation, it increases the threshold for conversion, and it requires a highly intense pump beam that is prone to damage the NLO crystal.

The beam walk-off can be compensated by bonding two identically oriented and same length nonlinear crystals in a 180° twist twin configuration. To be able to better design the walk-off compensated nonlinear crystal components, the walk-off effect is reviewed here for its practical implications in optic parametric conversion.

Variables for the design of WOC OPO components

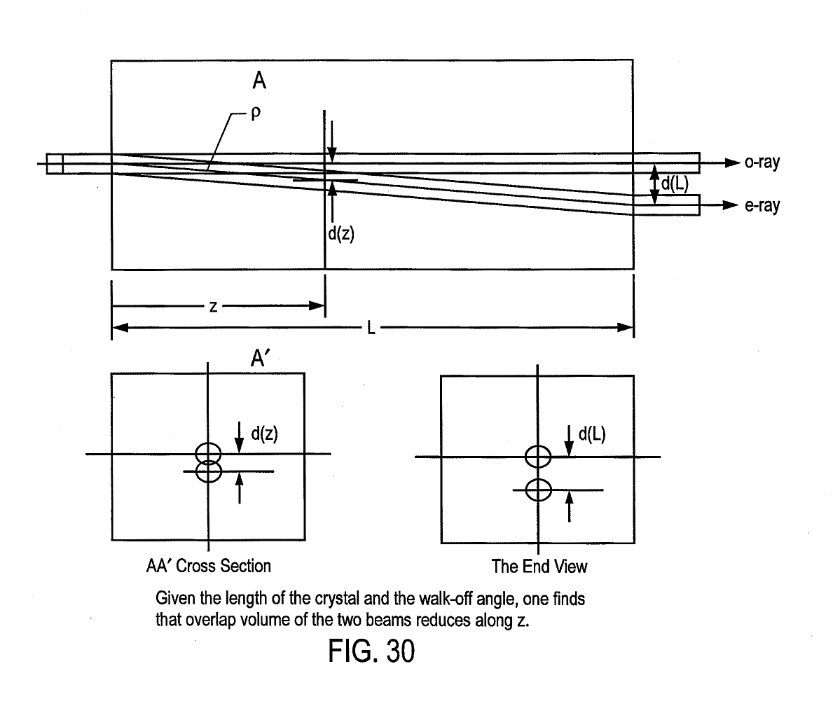

The correlation between the beam size and the overlap volume for a given walk-off angle and the length of the crystal is illustrated in FIG. 30. Interacting beams can only transfer energy within their shared space that is defined here as the overlap volume.

(i) Overlap Volume as Function of Walk-Off Angle and NLO Crystal Length for a given Beam Diameter, e.g. 0.5 mm:

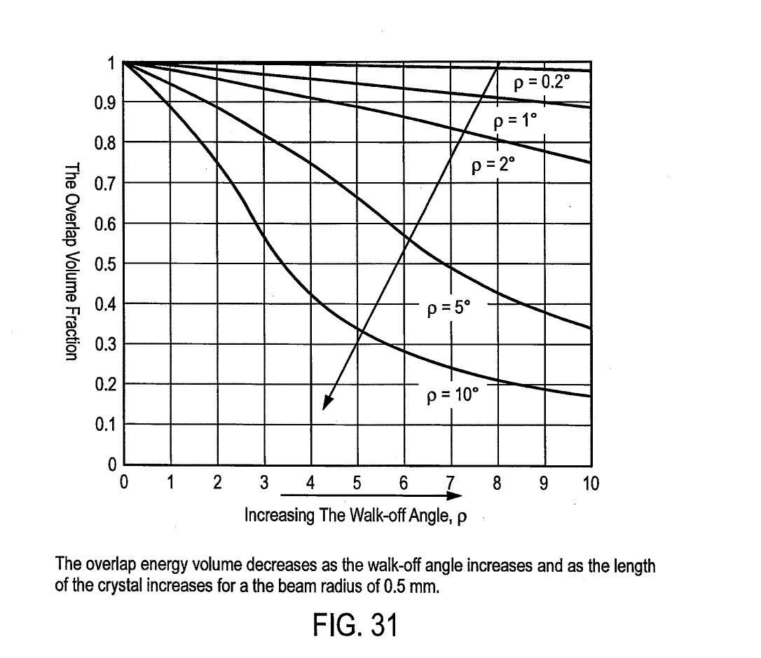

Considering two cylindrical beams first of uniform intensity distribution, the overlap volume allowing transferring energy diminishes as the beam propagating length increases as shown in FIG. 31.

(ii) Overlap Volume as Function of Beam Radius and Length z of the NLO Crystal for a given Walk-Off Angle, e.g. ρ=3°

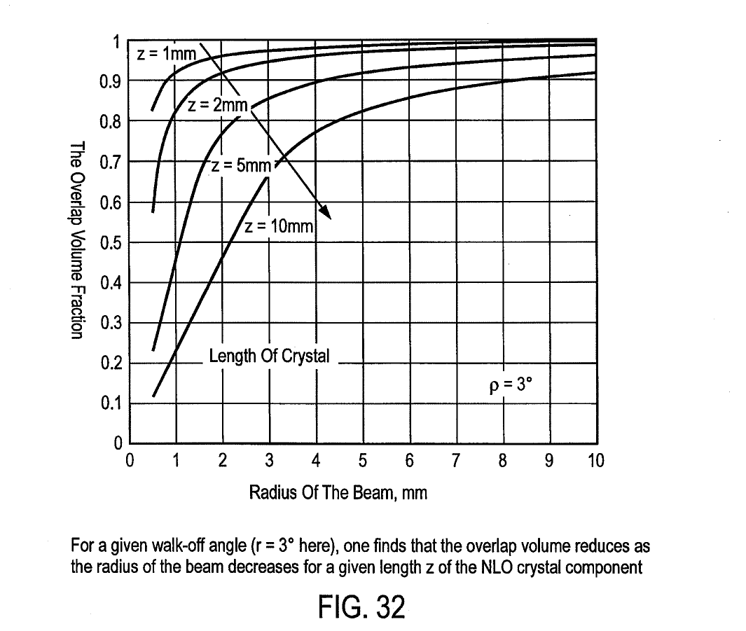

FIG. 32 shows that for a given walk-off angle (ρ=3° here), one finds that the overlap volume reduces as the radius of the beam decreases for a given length z of the NLO crystal component.

(iii) Gaussian Beams

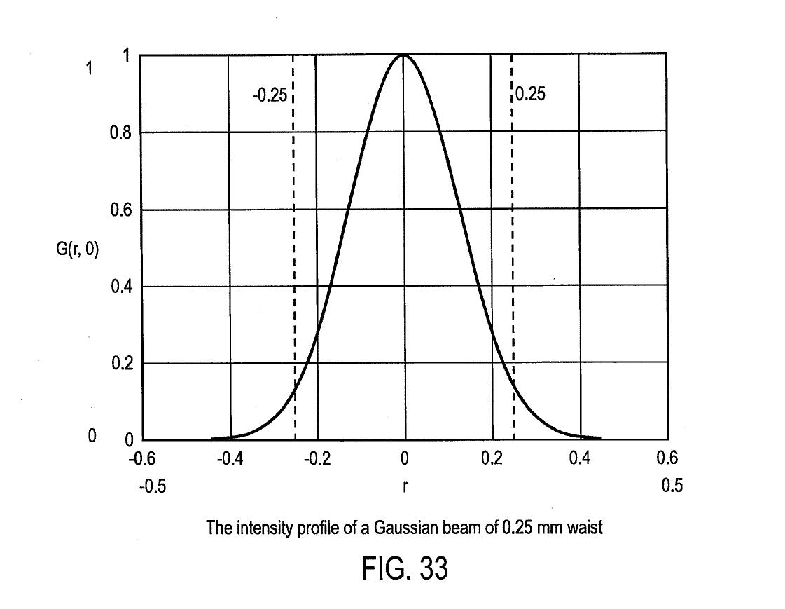

High power laser beams usually have Gaussian intensity profiles that are characterized by their beam waist, Rayleigh range, and normal radial distribution as shown in FIG. 33.

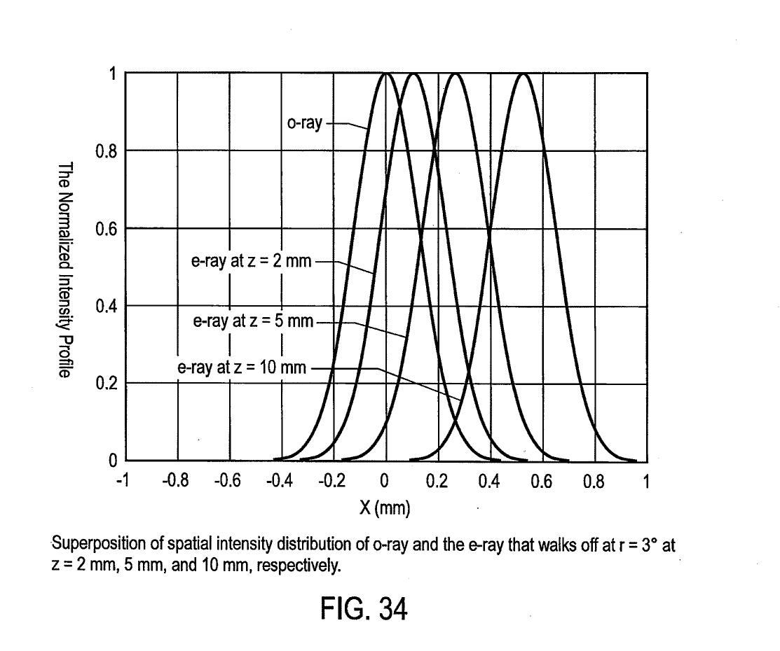

The e-beam walk off with respect to the o-beam may be illustrated by reduction of the overlap surface areas under the normal curve of the 0-ray and one of the normal curves of e-rays as shown in FIG. 34 for the example of walk-off angle of 3°. The same energy for both interacting beams is assumed here. It is an idealized case for illustration. In reality, the overlap energy is always less than in this case.

(iv) Energy Overlap of Two Gaussian Beams as Function of NLO Crystal Length z for Different Walk-Off Angles

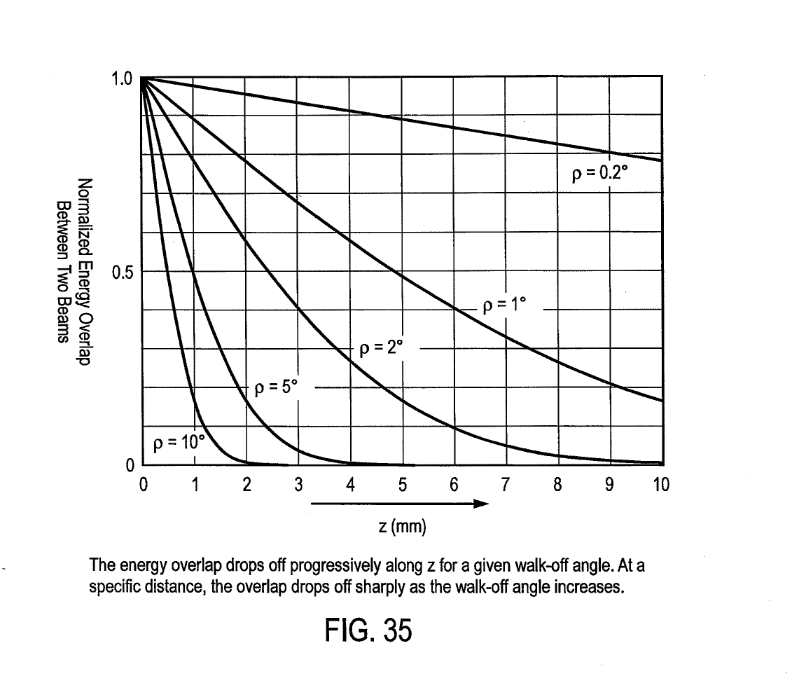

FIG. 35 shows that the energy overlap drops off progressively along z for a given walk-off angle. At a specific distance, the overlap drops off sharply as the walk-off angle increases.

(v) Cumulative Overlap Between Beams Affected by Walk-Off

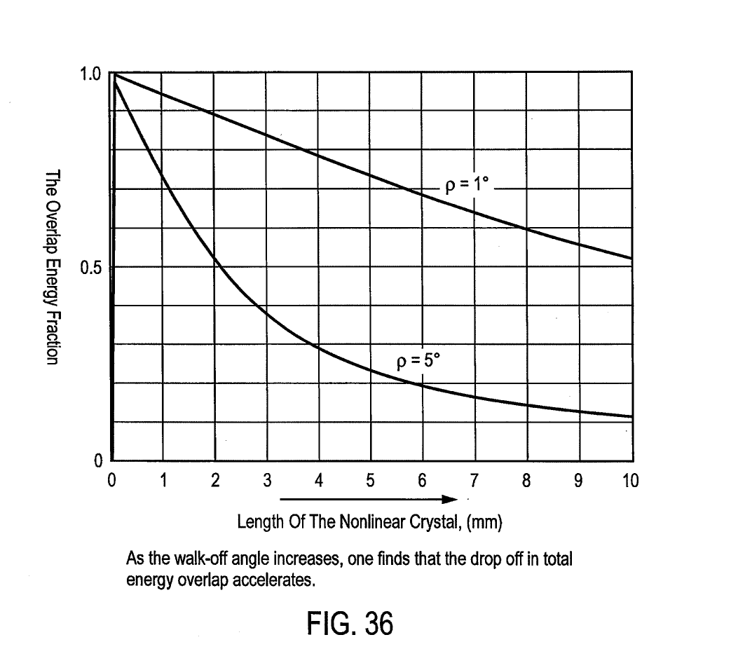

The overlap fraction between two beams with the walk-off angles 1° and 5°, respectively, along the propagating length direction diminishes as shown in the curves in FIG. 36. The calculated results shown here indicate that the walk-off is one of the critical limiting factors in optical parametric conversion, especially for the cases of critical angle phase matching arrangements.

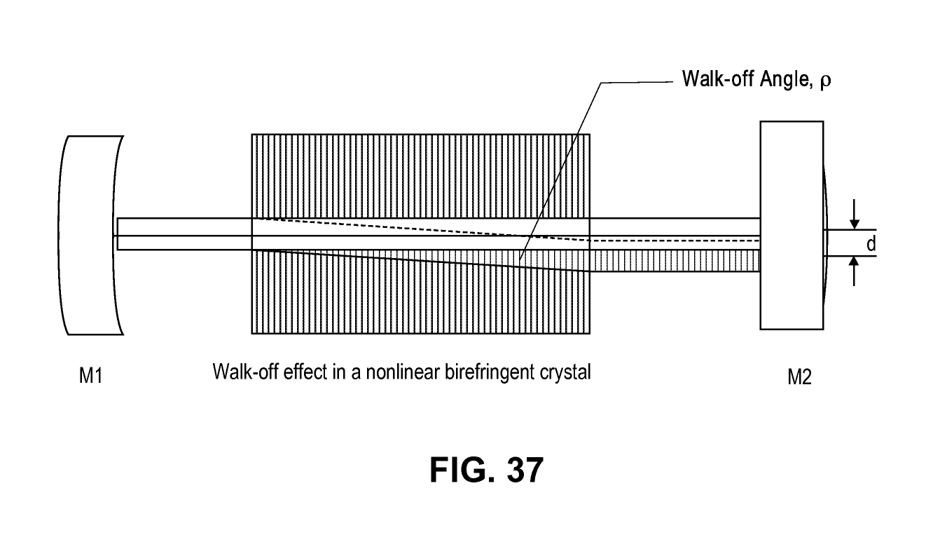

In the case of an OPO, one finds that the walk-off reduces efficiency by introducing loss in generated beams that have portions that deviate from resonance as shown in FIG. 37. Walk-off becomes a limiting factor for OPO efficiency. Unless one avoids using critical phase matching as the means for conversion, one has to take the effect into account.

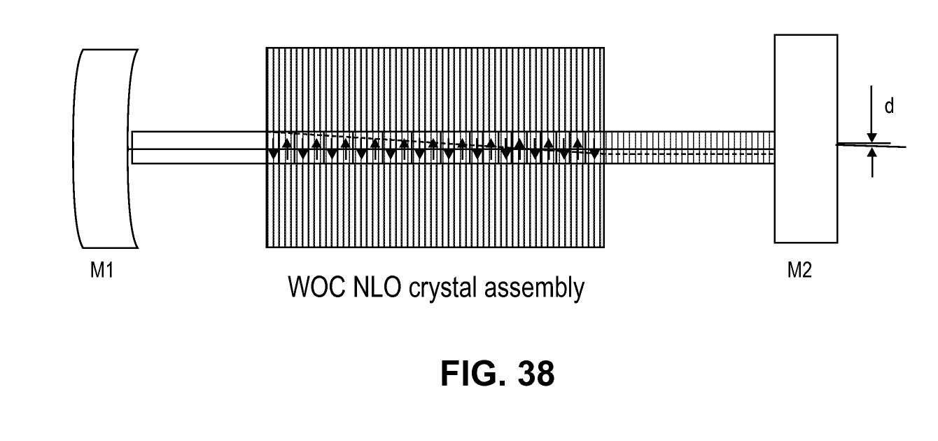

FIG. 38 shows schematically a WOC NLO crystal assembly in a confocal cavity where a large overlap is achieved in comparison to FIG. 36.

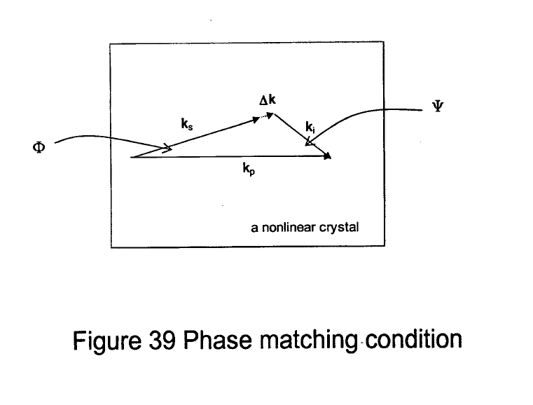

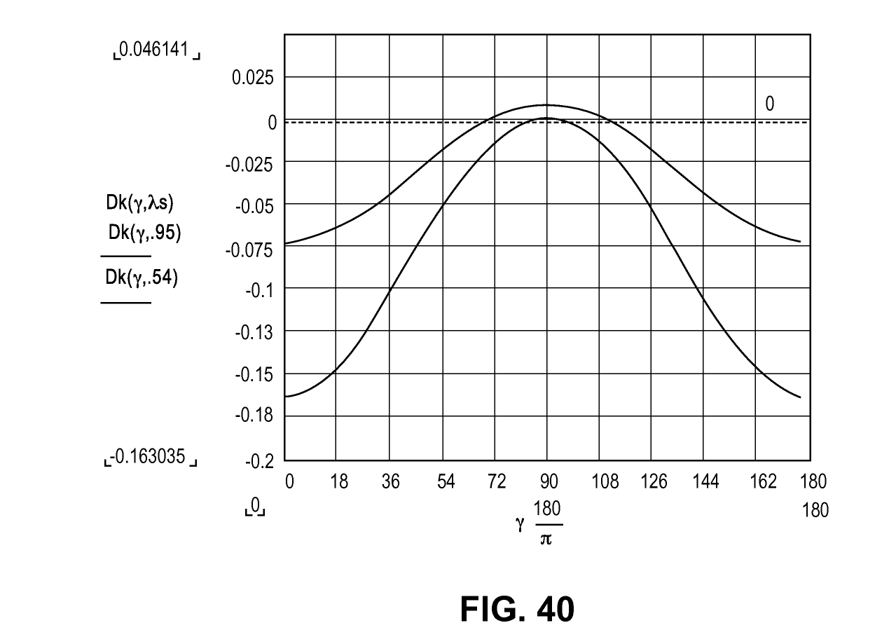

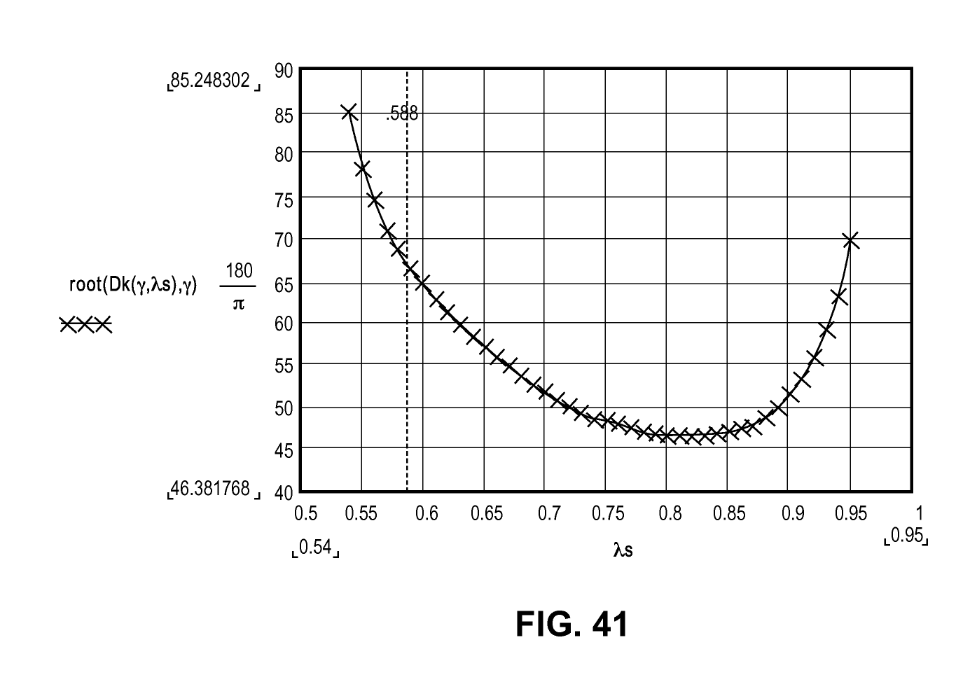

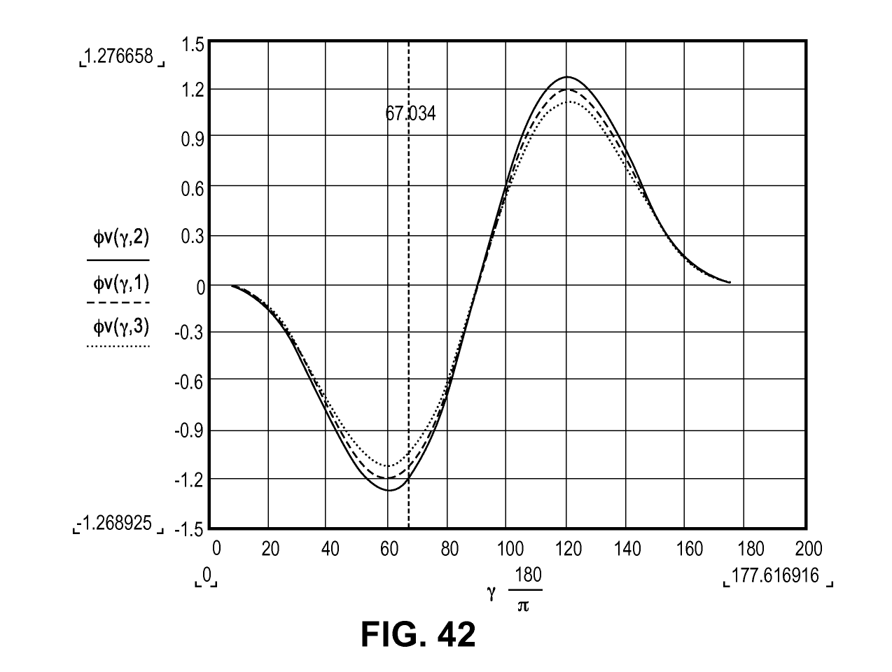

Because many application include the use of optical parametric oscillators, their background is reviewed by means of an example in Appendix A with reference to FIGS. 39-42.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1-16. (canceled)

17. An optical assembly capable of correcting walk-off of an impinging radiation beam, comprising:
a pair of identical critically phase matched nonlinear optical crystals, each crystal having a pair of opposing end faces, wherein the pair of crystals have the same length between end faces and the crystals each have an identical cut of an end face relative to an optical axis of the crystal,
wherein the pair of crystals are arranged with an end face of one positioned proximal to an end face of the other and with a 180 degree rotation of one crystal relative to the other along a direction of propagation of an impinging coherent radiation beam.

18. The device of claim 17, wherein the pair of crystals are frequency-converting uniaxial crystals or frequency converting biaxial crystals.

19-23. (canceled)
